(19) United States
(12) Patent Application Publication
(10) Pub. No.: US 2022/0148114 A1
(43) Pub. Date: May 12, 2022

(54) METHODS AND SYSTEMS FOR IMPLEMENTING AND MONITORING PROCESS SAFETY MANAGEMENT

(71) Applicant: ACM RISK SCIENCES & DEVELOPMENT INC., Calgary (CA)

(72) Inventor: Kenneth George BINGHAM, Rocky Mountain House (CA)

(21) Appl. No.: 17/438,680

(22) PCT Filed: Mar. 13, 2020
(86) PCT No.: PCT/CA2020/050343

§ 371 Date: Sep. 13, 2021

Related U.S. Application Data
(60) Provisional application No. 62/817,922, filed on Mar. 13, 2019.

(30) Foreign Application Priority Data
Mar. 13, 2019 (CA) 3,036,543

(51) Int. Cl. G06Q 50/26; G06Q 10/06

(52) U.S. Cl. CPC G06Q 50/265; G06Q 10/0633

(57) ABSTRACT

Methods and systems for monitoring and implementing process safety management of a facility comprise: conditioning a plurality of disparate process hazard analysis (PHA) and layer of protection analysis (LOPA) data sets to generate a relational database, the conditioning including: a) categorizing and classifying data elements of each PHA and LOPA data set, the categories and classifications consistent between all PHA/LOPA data sets; b) generating a plurality of hazardous scenarios by identifying a plurality of hazardous events and assigning said data elements to each hazardous event; c) grouping together two or more of said hazardous scenarios so as to generate a group representation. A risk analysis procedure is performed on an identified hazardous event in the relational database, the identified hazardous event belonging to at least one hazardous scenario forming at least one grouped representation.

### FIELD

The present disclosure relates to implementing and monitoring process safety management; in particular, the present disclosure relates to methods and systems for implementing and monitoring improvements to process safety where the improvements arise from process hazard analysis studies.

### BACKGROUND

Industrial facilities which handle or process unsafe chemicals, such as refineries, gas plants and upgrading plants, are comprised of engineered, complex systems for handling, utilizing and storing those chemicals. It is a reality that anything humans build or operate is vulnerable to failure. Facility operators undertake expensive hazard assessments of their facilities, in an effort to identify potential hazards and safeguards which will either prevent the hazardous event, or otherwise mitigate the consequences of a hazardous event. (As used throughout this document, the term “hazardous event” refers to events resulting in death or personal injury, and also refers to other types of unwanted events which result in, for example, negative economic or environmental impacts).

The process hazard analysis (“PHA”) and/or layer of protection analysis (“LOPA”) requires the investigation of deviations from design intent for a process or system by a team of individuals with expertise in different areas, such as engineering, chemistry, safety, operations, and maintenance. (Hereinafter, the terms PHA and LOPA are used interchangeably). The PHA is based on the principle that several experts with different backgrounds can interact and better identify problems when working together than when working separately and combining their results.

A typical PHA or LOPA study results in a number of spreadsheets containing raw PHA or LOPA data. As shown in FIG. 1, a first facility 100 may perform a PHA study, resulting in a pile of spreadsheets 102 containing recommendations for improving safety at facility 100; similarly, a second facility 110 may perform a PHA study resulting in a pile of spreadsheets 112 and a third facility 120 may perform a PHA study resulting in a pile of spreadsheets 114. None of the facilities 100, 110, 120 have any access to the results of the PHA studies of the other facilities. The PHA raw data, contained in the spreadsheets 102, 112 and 114, consists of natural language descriptions of different facility components, hazardous events associated with those components, causes and consequences of hazardous events, the safeguards that are presently in place, and recommended safeguards which are designed to lower the risk of a hazardous scenario potentially occurring.

Despite the resources directed to hazard assessments, unsafe days can and do occur. The term “unsafe days” refers to the hazardous events that may occur from time to time at a facility—examples of such hazardous events include fires, explosions and the release of contaminants into the environment, potentially resulting in injuries or death, damage and environmental harm. When unsafe days occur, the cost to the facility's operators, in terms of harm to employees, loss of production, capital loss, lowered stock price, possible liability, and reputational harm, can be significant. Typically, the response to an unsafe day involves engaging in a detailed investigation of the events and, with the benefit of hindsight, solutions are engineered to reduce the likelihood of that specific hazardous event (or incident, or accident) from recurring in the future. In this manner, solutions are identified and implemented in response to a hazardous event, resulting in an incident or an accident: one fix at a time, one facility at a time, after a loss has already occurred.

Because the process safety endeavours described above are directed to reducing or mitigating known hazards, or preventing a hazardous event which has already occurred from developing again in the future, such endeavours are focused on addressing the causes of hazardous scenarios that are already known, while sometimes failing to identify other, unknown hazardous scenarios which may develop in the future. Because the process units, systems and processes of a given facility are typically complex and involve many components (such as structures, or pieces of equipment) which affect one another, it may not be possible for a team of engineers and professionals at a particular facility to identify every possible hazardous scenario when undertaking a PHA study.

Furthermore, when an unsafe day occurs and an investigation is carried out on the accident or incident, the resulting reports and recommendations are typically not shared outside the facility, or beyond the operator of the facility. Therefore, other facilities owned by different operators typically do not receive the benefit of the information and recommendations generated when reviewing a hazardous event at a particular facility.

When a PHA or LOPA study is performed, it will typically generate a large number of recommendations for improving process safety. The cost of implementing these recommendations may range from low to high cost, and the difficulty of implementing such recommendations may also range from simple to very difficult. Because it is usually impractical to implement all of the recommendations at the same time, facility managers must prioritize which recommendations are implemented, or which are implemented first. Such decisions are normally driven by budget and convenience considerations, in the absence of information as to which recommendations may have the greatest impact on reducing the identified risks.

Ideally, after completing a PHA or LOPA study, the facility operator should continually seek to improve safety over time. A PHA or LOPA study typically provides a snapshot in time of the safety status of the facility, and a list of recommendations to improve safety, which list of recommendations may be implemented, or not, over a period of time following completion of the PHA or LOPA project. However, the facility itself does not remain static over time, and as changes are made to the facility, the likelihood of various hazardous scenarios materializing will also change over time, which may impact the effectiveness of the recommended safeguards on reducing or mitigating such risks. Furthermore, after a facility operator spends significant money on implementing various recommendations derived from a PHA or LOPA project, the facility operator may tend to believe that the safety improvements implemented are sufficient to address the risks identified, when in fact the risks, and safeguards required to prevent or mitigate the hazardous events from materializing, may change to the extent that the effectiveness of those recommendations is reduced or eliminated.

### SUMMARY

The applicant has discovered that identifying and defining the interrelationships between different elements of a facility, including elements of the process units of the facility, and calculating the impact of each of those elements on the risk that a hazardous scenario will develop into a hazardous event, enables the ability to apply data analytics techniques to such PHA and LOPA data so as to derive useful information and insights about improving process safety of that facility.

In one aspect, conditioning a plurality of disparate PHA and LOPA data sets, such as disparate written reports generated for facilities of different owners or operators and possibly extending across different industries, so as to classify and uniformly categorize the individual data elements of each data set, results in the generation of a relational database containing PHA data elements from the plurality of disparate PHA data sets, which may then be compared and analysed across the relational database. Conditioning the data may further include mapping additional information or data (herein, described as “metadata”) onto the existing, categorized data elements, which metadata may be utilized to obtain additional insights into the interrelationships between the data elements, and enhance the insights that may be extracted by applying analytics to the conditioned PHA data.

In addition to classifying and categorizing the PHA data, the conditioning may preferably further include grouping together data elements around an identified hazardous event, so as to create a so-called “bowtie” visual depicting a hazardous scenario, showing the interrelationship of the data elements (in other words, the causes, consequences, and safeguards), relating to that hazardous event. Furthermore, the relationships between hazardous scenarios may be identified by, for example, identifying data elements which exist in two or more hazardous scenarios, and on that basis linking together the two or more hazardous scenarios so as to obtain a more comprehensive understanding of the risk associated with hazardous scenarios sharing the same hazardous event, consequence severity and point of reference (for example, the hazardous scenarios existing in the same area of a facility).

In another aspect, analytics, which are used to track whether operative and strategic process safety goals are being met, may be assembled into sets so as to produce a graphical representation of a profile of that facility; examples of graphical representations of the profile may include, but are not limited to, a profile line or a radar chart. The profile of the facility may then be compared to a benchmark profile, which is generated from the data contained in the relational database of a set of comparable benchmark facilities. This comparison of the facility's profile against a benchmark profile may provide an efficient visual indication of whether a facility is achieving its process safety goals, as compared to the benchmark profile.

Additional aspects, including those described below, build upon the conditioning of the PHA data sets and applying analytics to the processed PHA data, described above. In another aspect, data analytics may be applied to the relational database to identify which of the data elements of a given category are most critical; for example, identifying the most critical hazardous scenario, or cause, or safeguard. Identifying the most critical safeguards, for example, may enable the prioritization of recommended safeguards so as to reduce the risk of unwanted, or hazardous, events from occurring.

Another aspect may include using the PHA and/or LOPA data to validate the known standards and processes. For example, where the same type or category of safeguard is used in the same instance to reduce the same frequency or the same hazardous event is not permitted, but may be identified when performing analytics on the PHA/LOPA data. Analytics provides consistency of the application or PHA, and LOPA, or any other type of risk analysis processes.

In another aspect, data analytics may be applied to the relational database to determine the probability of a hazardous event or a consequence occurring within a selected timeframe, within different frames of reference of the facility. For example, it may be predicted that a hazardous event “X” has a probability of 82% occurring within the next five years. The frame of reference may include, for example, assuming that all of the safeguards are in place; assuming that none of the safeguards are in place; or assuming that the actual safeguards of the facility are in place, at the time the predictive inquiry is made. The scope of PHA/LOPA data taken into account in the predictive calculation may include, for example, predicting a particular hazardous event “X” may occur in a process unit; a facility; or across any of the facilities of the operator. Applications for such an insight may include, but are not limited to, enabling a facility operator to realize that a hazardous event is imminent, thereby causing the operator to take action on implementing or maintaining safeguards.

In another aspect, the processes and techniques described herein may be applied to combine risk and financial information by quantifying the amount of risk reduction of a safeguard and comparing that risk reduction to the actual cost of the safeguard, thereby producing a return on investment (“ROI”) metric of each safeguard. Such insights may be utilized by a facility manager to prioritize improvements to process safety based on which recommendations will yield the greatest risk reduction, relative to the cost of implementing that improvement to process safety.

The systems and methods described herein may therefore enable facility managers to leverage not only the engineering knowledge of personnel at a given facility, but also leverage the engineering knowledge and learnings generated from process hazard assessments and unsafe day studies from numerous other facilities. In some instances, leveraging such broad sets of data may generate identification of previously unknown risks or hazardous scenarios in a given facility. In other instances, the methods and systems described herein may enable extracting additional insights and recommendations regarding how to improve safety of a single facility, based only on PHA and/or LOPA data generated for that single facility, because the methods and systems described herein may enable improved prioritization of recommended safeguards by identifying the most critical hazardous scenarios, safeguards and recommended safeguards by identifying the interrelationships between different hazardous scenarios (graphically represented by bowtie diagrams) and thereby taking into account the total impact of various safeguards on different hazard scenarios which are interrelated. Furthermore, in some aspects of the present disclosure, performing analytics on the data in the relational database may include ranking the hazardous scenarios, the causes, the safeguards and the consequences to thereby identify, for example: which safeguards are most critical and should therefore be implemented first; the prioritization of which safeguards should be tested and maintained; identifying which safeguards should be recognized and understood, and implemented first.

In an aspect of the present disclosure, a method for improving process safety of a facility of an operator comprises: conditioning a plurality of PHA and/or LOPA data sets to generate a relational database, wherein at least one PHA and/or LOPA data set relates to the facility, the conditioning steps including: a) categorizing and classifying data elements of each PHA or LOPA data set into corresponding categories and classifications which are consistent between all PHA or LOPA data sets; b) generating a plurality of hazardous scenarios by identifying a plurality of hazardous events and assigning said data elements to each hazardous event; c) grouping together two or more of said hazardous scenarios so as to generate a group representation, wherein the said two or more hazardous scenarios share at least a common hazardous event and a common said data element. A risk analysis procedure is performed on one or more identified hazardous events in the relational database, the identified hazardous event(s) belonging to at least one hazardous scenario forming at least one grouped representation in the relational database, the performance of the risk analysis procedure comprising: a) identifying one or more causes of the identified hazardous event and a frequency of each identified one or more causes; b) identifying one or more safeguards of the identified hazardous event impacting each cause and a probability of failure on demand (PFD) of each identified safeguard; c) calculating a mitigated frequency of each cause of the identified hazardous event by multiplying the frequency of each cause by the PFD of each safeguard impacting each cause; d) calculating a total mitigated frequency of the identified hazardous event by summing the mitigated frequency of each cause; e) comparing the total mitigated frequency to a tolerable frequency of the identified hazardous event; f) outputting a recommendation for reducing the risk of the identified hazardous event of the facility when the total mitigated frequency exceeds the tolerable frequency. The method may further include the step of implementing the at least one recommendation of the plurality of recommendations at the facility.

Where no PHA or LOPA data sets exist, in one aspect of the present disclosure, the tool may provide for the generation of an interim PHA data set auto-generated from known data sets, the known data sets based on PHA or LOPA studies on a facility or process unit having the same major components or equipment as the facility or process unit being analysed. Performing risk analytics on such data may be performed for a given facility without a PHA being executed specifically on the facility or process unit being analysed. Such analytical results may be considered as an interim risk analysis until a PHA can be directly executed on a known site. The interim data may be treated as an additional data set in the recaptured data base, herein referred to as “IDATA”.

In another aspect, the categories referred to in the above method may be selected from the group comprising: a cause, a safeguard, a recommendation, a consequence.

In another aspect of the method described above, the step of conditioning a plurality of PHA data sets further includes classifying a severity of the consequence of each hazardous scenario of the plurality of hazardous scenarios; and wherein the step of grouping together two or more hazardous scenarios includes selecting two or more hazardous scenarios for grouping together which two or more hazardous scenarios share equally classified severity of consequences.

In another aspect of the above method, the common data element is a safeguard and the step of grouping together two or more hazardous scenarios includes grouping together at least a hazardous scenario of the facility and a hazardous scenario of at least a second facility. In some embodiments, the second facility is operated by a second operator unrelated to the first operator.

In another aspect of the present disclosure, the step of performing analytics on the relational database, in the methods described above, may include performing a criticality analysis on a selected category of data elements of the facility, and the output of the performed analytics includes identifying at least one recommendation including a plurality of recommended actions, where the plurality of recommended actions each comprise comparatives and a risk reduction categorization. These recommendations allow risk analysis to determine a prioritized basis for the recommended actions. In another aspect of the above methods, the at least one recommendation comprises implementing a new safeguard.

In another aspect of the present disclosure, a method for improving process safety of a facility by identifying patterns in process hazard analysis data obtained from a plurality of facilities comprises the steps of: a) conditioning a plurality of PHA data sets obtained from the plurality of facilities so as to generate a relational database wherein at least one of the processed PHA data sets relates to the facility, the relational database comprising: processed data elements; a plurality of hazard scenarios, each hazard scenario having assigned data elements selected from the processed data elements; and group representations, the group representations generated by grouping together two or more hazard scenarios wherein the two or more hazard scenarios share at least one common assigned data element; the steps of the method further including: b) performing analytics on the plurality of hazard scenarios in the relational database to output a high level summary (First Learnings) of the hazard scenarios of the facility, the performing analytics comprising: identifying one or more causes and the frequency of each identified one or more causes; identifying one or more safeguards of the first hazardous scenario impacting each cause and a probability of failure on demand (PFD) of each identified safeguard; calculating a mitigated frequency of each cause of the first hazardous scenario by multiplying the frequency of each cause by the PFD of each safeguard impacting each cause; calculating a total mitigated frequency of the first hazardous scenario by summing the mitigated frequency of each cause; comparing the total mitigated frequency to a tolerable frequency of the first hazardous scenario; and outputting the recommendation for reducing the risk of the first hazardous scenario of the facility when the total mitigated frequency exceeds the tolerable frequency, wherein the recommendation comprises adding a new safeguard.

In another aspect of the present disclosure, a method for improving process safety of a facility by performing risk analytics on PHA and LOPA data sets obtained from a plurality of facilities is provided, the method comprising: (a) digitizing the PHA and LOPA data sets by categorizing and classifying data elements of the said data sets into categories and classifications, the categories and classifications standardized across the said data sets so as to generate a relational database; (b) performing risk analytics on the data elements of the relational database so as to generate groupings of said data elements; (c) compiling the said groupings of each facility of the plurality of facilities to generate a profile of each facility; (d) analysing the profile of each facility to generate one or more recommendations to reduce the risk of the at least one hazardous event occurring; and (e) implementing the one or more recommendations at the facility. In some embodiments, the step of analysing the profile of each facility includes comparing the profile of each facility to the profiles of each other facility of the plurality of facilities to identify similar facilities. The step of comparing the profile of each facility to the profiles of each other facility may include predicting a percentage of total discovered risks of a selected facility based on the calculated percentage of total discovered risks of a similar facility, wherein a selected group of facilities is ranked in order of priority by prioritizing the facilities with the lowest predicted percentage of total discovered risks for generating and implementing recommendations. In some embodiments, the step of implementing the one or more recommendations includes implementing at least one safeguard.

In this disclosure, the phrase “unknown facility” refers, in one aspect, to a facility on which PHA and/or LOPA studies have been performed to generate PHA and/or LOPA data sets of the unknown facility, but only partial risk analytics (or “partial analytics”) have been performed on the conditioned data of the PHA and/or LOPA data sets. Partial analytics may include, for example, generating one or more profile lines of the unknown facility based on First Learnings, or on First Learning and Group Learnings, for that unknown facility. Whereas, “full analytics” may refer to, for example, performing all or most of the types of analytics or Learnings that are disclosed in the present disclosure.

In another aspect of the present disclosure, a method for improving process safety of an unknown facility by performing risk analytics on process hazard analysis (PHA) and layer of protection analysis (LOPA) data sets obtained from a plurality of facilities, the method comprising: digitizing the PHA and LOPA data sets by categorizing and classifying data elements of the said data sets into categories and classifications, the categories and classifications standardized across the said data sets so as to generate a relational database; performing full analytics on the data of the plurality of facilities in the relational database to generate a profile of each facility; performing partial analytics on the data of the unknown facility to generate an initial profile of the unknown facility; comparing the initial profile of the unknown facility to the profiles of each facility of the plurality of facilities to identify facilities having a risk profile that is predicted to be similar to the risk profile of the unknown facility; predicting a percentage of total discovered risks of the unknown facility based on a calculated percentage of total discovered risks of the one or more facilities having a similar risk profile; wherein a selected group of unknown facilities is ranked in order of priority by prioritizing the unknown facilities with the lowest predicted percentage of total discovered risks for performing the full analytics so as to validate one or more recommendations associated with the PHA and LOPA data sets of the unknown facilities.

In another aspect, the method may include the step of implementing the validated recommendations of the unknown facilities that have been prioritized. The step of implementing the validated recommendations of the unknown facilities may further include implementing one or more recommended safeguards. The step of performing partial analytics on the data of the unknown facility to generate an initial profile of the unknown facility further includes generating groupings of data elements. The step of implementing the one or more recommendations includes implementing at least one safeguard.

### BRIEF DESCRIPTION OF THE FIGURES

FIG. 1 is a diagram illustrating an aspect of the prior art.

FIGS. 2A and 2B are line graphs, according to an aspect of the present disclosure.

FIGS. 3A-3D are bowtie diagrams, according to an aspect of the present disclosure.

FIG. 4 is a schematic, according to an aspect of the present disclosure, illustrating the calculation of a mitigated frequency of a grouped representation.

FIG. 5 is a graphical representation of critical data elements, according to an aspect of the present disclosure.

FIG. 6 is an example calculation of the frequency of a consequence excluding a safeguard, according to an aspect of the present disclosure.

FIG. 7 is an example calculation of the frequency of a consequence including a safeguard, according to an aspect of the present disclosure.

FIGS. 8A-8B are graphical representations of residual risk accumulation, with and without safeguards in place, in accordance with an aspect of the present disclosure.

FIGS. 9A-9C are graphical representations of residual risk accumulation, with and without safeguards in place, in accordance with an aspect of the present disclosure.

FIGS. 10A-10C are a bowtie diagram and accompanying calculations provided as an example of a predictive calculation on the hazardous scenario depicted in that bowtie diagram, in accordance with an aspect of the present disclosure.

FIGS. 10D-10I are further examples of the predictive calculation on the hazardous scenario depicted in the bowtie diagram of FIG. 10A.

FIG. 11A is a block diagram illustrating the elements of the Process Safety Management System, including independent protection layers, in accordance with an aspect of the present disclosure.

FIG. 11B is a logic flow diagram illustrating a process for benchmarking in relation to profile learnings, in accordance with an aspect of the present disclosure.

FIGS. 12A-12F are a series of schematic diagrams illustrating the application of an ideal facility in relation to profile learnings, in accordance with an aspect of the present disclosure.

FIGS. 13A-13F are a work flow diagram for PHA analytics, in accordance with an aspect of the present disclosure.

FIG. 14 is a graphical representation of risk discovery as compared between different processing units, in accordance with an aspect of the present disclosure.

FIGS. 15A-15B are a graphical representation of the process of risk discovery without predictive analytics as compared to the process of risk discovery with predictive analytics.

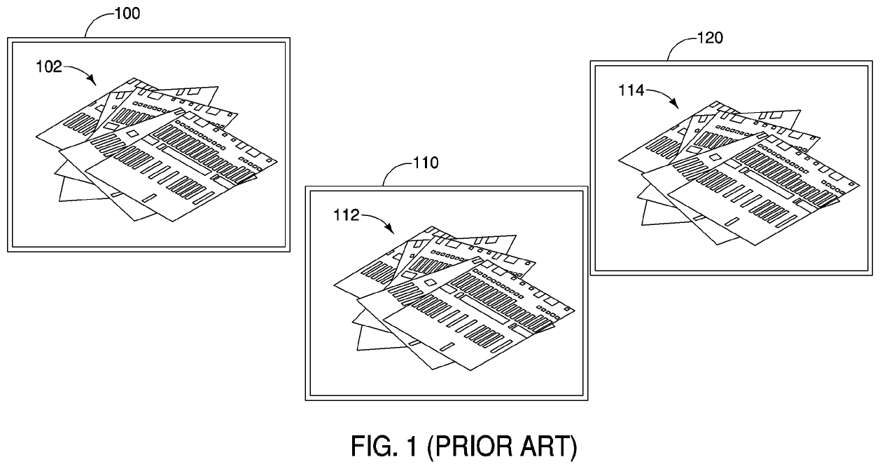

### DETAILED DESCRIPTION

Learnings Generator—First Learnings

PHA analysis requires the investigation of deviations from design intent for a process or system by a team of individuals with expertise in different areas, such as engineering, chemistry, safety, operations, and maintenance. During a PHA study, the team is responsible for assessing the process risk materializing from various process deviations, and determining the consequence and severity of potential hazardous events that may occur, including the identification of cause-consequence pairs relating to each potential hazardous event identified. The team lists all safeguards that may be used to either prevent the hazardous event from happening, or to mitigate the consequences resulting from the hazardous event. The resulting data consists of natural-language descriptors of hazardous events, the causes and consequences of those hazardous events, and the safeguards which may prevent or mitigate the hazardous event. Each descriptor may be considered a “data element” of the PHA data set.

The raw PHA data captured in the studies described above may be processed and loaded into a relational database, in a process referred to herein as “pre-conditioning the data”. In some embodiments of the present disclosure, pre-conditioning the raw data includes manually reviewing the PHA data, such as may be presented in a spreadsheet, and assigning metatags to each data element which ascribes certain attributes to the data element. For example, conditioning the data may include manually reviewing each data element, which is for example a Cause, Safeguard, Recommendation or a Consequence, and categorizing that particular data element as one of a fixed list of categories. For example, there are four different “Cause” categories; namely, Human Error, Equipment Failure, External Event or Undetermined. Furthermore, each data element which is a Safeguard may be classified as either a “Preventative” safeguard, because the safeguard prevents the hazardous event from potentially occurring; or a “Mitigative” safeguard, because the safeguard avoids or reduces the potential impact (or consequences) of the hazardous event that has occurred. Both preventative and mitigative safeguards are considered to be risk mitigating, or in other words, mitigating the likelihood of the consequences from potentially occurring. Furthermore, conditioning the data may also include classifying the severity of each of the data elements categorized as “consequences”, for example on a scale of 1-5, where a severity of “1” indicates the least severe consequence, while a severity of “4” or “5” represents the most severe consequence (such as death or injury, destruction or significant damage to a processing unit, significant release of contaminants into the surrounding environment). The severity and likelihood are extracted using risk matrices, which are also considered to be data elements.

Additionally, in some embodiments, pre-conditioning the data includes associating additional information about each data element with the data element contained in the relational database. For example, associating specific pieces of equipment with particular safeguards, and relating the piping and instrument diagrams to those pieces of equipment to show how the equipment interacts with each other. Another example may be associating a particular equipment component, which is a safeguard, with the equipment's recommended and actual testing and maintenance schedule. Such additional information associated with the individual data elements may enable the application of various types of analytics so as to obtain insights about risks in the facility, as will be further described below.

Although pre-conditioning the PHA data, described above, may be accomplished manually by a person reviewing a spreadsheet and applying metatags to each data element, the metatags based on the categorization and classification of the data, it will be appreciated by a person skilled in the art that other means or methods of pre-conditioning the PHA data may include, for example, automated conditioning, which may utilize artificial intelligence or machine learning to review the natural language descriptors of the PHA data elements and utilize algorithms for completing the classification and categorization of that data.

The utility of pre-conditioning the raw PHA data is, in one aspect of the present disclosure, to enable comparison and identifying interrelationships between individual data elements across different PHA data sets, which may, for example, be unrelated as being obtained from different facilities of an operator, or even different facilities of different operators. The PHA data being compared may also span different industries. Before pre-conditioning has occurred, the raw data sets obtained from PHA studies of different facilities is generally not comparable to other PHA data sets, because of the absence of a standardized manner of describing the different data elements, such as the safeguards, hazards, causes and consequences of a hazardous event. Advantageously, the Applicant has discovered that defining “risk”, which is common across threats, impacts and risk reduction methods (ie: safeguards), regardless of the type of facility or industry, that pre-conditioning the raw PHA data is required to expand the scope of available PHA data upon which to perform data analytics so as to derive insights into process safety hazards existing in a particular facility. Advantageously, this enables the identification of all hazardous scenarios or risks in all data sets, regardless of the type of facility on which the PHA analysis is being performed.

Once pre-conditioned, the data is loaded into a relational database, enabling these individual data elements to be exposed to users with intent to gather information. The interaction of these individual data elements extracted from the PHA data set may be referred to as “First Learnings”, and form the basis for all other relational learnings that are generated by applying various risk analytics to the data, generating what are otherwise referred to herein as “Profile Learnings.”

Risk Analysis and Risk Assessment

Hazard Identification and Risk Analysis is an activity performed to estimate the risk level of a hazardous scenario, and consists in answering the following fundamental questions:
(1) What can go wrong that could lead to a hazard event (wherein, a “hazard event” refers to an unacceptable harm to people, the environment, reputation, assets, located inside or outside the facility) and then, if left unmitigated, leading to a significant loss event?
(2) How likely is the hazardous event to happen (as defined by the frequency of the threats)?
(3) If the hazardous event happens, what is the severity or the consequences resulting from the hazardous event?

Risk is a combination of the probability of the occurrence of a harm (otherwise referred to herein as a “consequence”), and the severity of that harm or consequence. (See technical standard IEC 61511-1, 3.2.64). Assuming continuous exposure to the hazardous situation, risk may therefore be calculated as follows:

Risk=Probability×Consequence(Severity) Equation 1

Profile Learnings

In one aspect of the present disclosure, Profile Learnings consist of analytics applied to the processed data contained in the relational database, enabling measurement of various different performance indicators that are of particular interest to a facility operator. The range of analytics is broad, and may focus on any number of elements in a given facility. For example, analytics relating to causes, consequences, preventative safeguards and/or mitigating safeguards may be generated, allowing for the ease of identification of the specific, significant ways in which one facility differs from a base line benchmark set of comparator facilities, thereby providing insights which assist an organization to achieve their process safety objectives.

A core component of Profile Learnings is the analytics which produce insights into the performance of the facility, and performance questions regarding those insights. Analytics may help organizations understand how well they are performing in relation to their strategic and/or operational goals and objectives. In general, an analytic provides performance information which may enable organizations, or their stakeholders, to understand whether the organization is on track towards achieving their process safety objectives. One example of how the Profile Learnings may be presented, without intending to be limiting, is by creating a profile line representing the performance of the facility, and comparing the facility's profile line to the profile line of benchmark facilities or representative samples of benchmark facilities, so as to quickly and readily identify the differences between the facility of interest and the comparator or benchmark facilities. A person skilled in the art will appreciate that profile lines are just one example of a graphical representation that may be used to represent the profile of a given facility or processing unit within the facility, and that other graphical representations may be utilized, such as radar charts.

There are many types of analytics, two of which include, for example, operational and strategic analytics. Analytics may be relative to an entire facility, or specific to a point of reference inside the facility (for example, areas in the facility, process units in the facility, specific process equipment within the facility).

One type of analytics is to benchmark the performance of a given facility against a chosen benchmark population of other facilities; for example, the benchmark facilities may be other facilities of the operator; or similar facilities of other operators, unrelated to the first operator, in a given industry. Another application of safety performance analytics is to drive assessment of a facility's safety performance, by highlighting areas of concern that require investigation and action.

Advantageously, the use of profile lines enables the prediction of hazards, threats and safeguards, without having to conduct a detailed analysis on every data set, by leveraging the data obtained from detailed analyses performed on other facilities or processing units.

Profile Learnings—Examples of Performance Questions to Summarize on a Profile Line or Radar Chart Below are some illustrative examples, not intended to be limiting, of safety performance questions and their associated analytics:
1. Profile lines can help answer specific questions related to Safeguards:
   a) Is the process system design inherently safe?
   b) Do I have too many conditional modifiers in the HAZOP?
   c) How reliant are we on our people to provide us with safeguards?
   Examples of safeguard analytics comprising a profile line may include:
   a) Number of high-risk hazardous scenarios before safeguards to total number of scenarios before safeguards;
   b) Percent reliance on occupancy as a safeguard;
   c) Number of human-dependent safeguards to the total number of safeguards;
   d) Risk reduction from recommendations to risk reduction from safeguards.
2. Profile lines can help answer specific questions related to Recommendations:
   a) What recommendation types provide us with the greatest Risk Reduction Factor?
   b) How much Risk Reduction Contribution am I getting from Human Dependent Recommendations?
   c) What receptors are my recommendations safeguarding?
   Examples of Recommendation Analytics which comprise a profile line may include:
   a) Risk Reduction Contribution (“RRC”) of mechanical safeguard recommendations to total RRC
   b) RRC of human-dependent recommendations to total RRC;
   c) Financial receptor safeguard contribution of recommendations.
3. Profile lines can help answer specific questions related to Recommendations:
   a) Are our recommendations giving us a valuable return on investment?
   b) Which safeguard types give us the largest return on investment?
   Examples of Recommendation Analytics which comprise a profile line could include:
   a) Number of Category 1 recommendations compared to increase in ROI
   b) ROI for category 4 safeguards compared to total ROI

Profile Learnings—Graphical Representations

By assembling analytics into different sets, a Profile Line allows the user to observe the analytics set or sets in a single, graphical representation, and thereby focus on answering a specific safety performance question of interest. Profile Lines may contain Profile Learnings to assist in tracking operational performance and provide an indication as to whether the organization is tracking towards its strategic goals.

From the Learnings data calculated through performing analytics on the PHA data sets, hundreds of analytics have been developed, which may be used to benchmark a particular facility's PHA analytics against a chosen baseline. The baseline may be comprised of any available data set; for example, not intended to be limiting, the baseline may comprise peer facilities within the same operator, or peer facilities of other operators. The data in the baseline datasets may also, for example, be selected on the basis of geography, facility type, hazardous chemical, or any number of other characteristics for establishing a baseline profile.

In summary: Strategic analytic measures are about monitoring progress toward achieving a envisioned corporate policy (as opposed to just doing things better). As a result, strategic analytic performance measures do not change often. Whereas, with operational analytic performance measures (doing things better), it is desirable to get closer and closer to “real time” measurement in order to achieve the specific objectives set by a policy.

Profile Learnings—Benchmarking Road Map

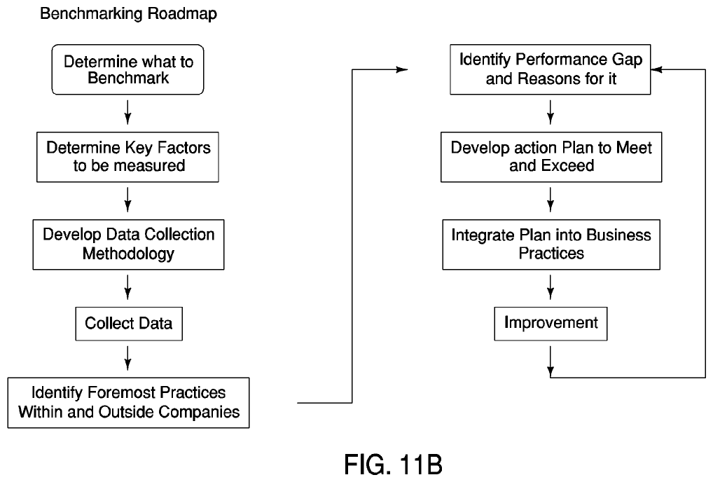

The process of selecting a benchmark, for comparison against a profile line of a facility, is described in the process diagram at FIG. 11.

Profile Learnings—Hypothetical Examples

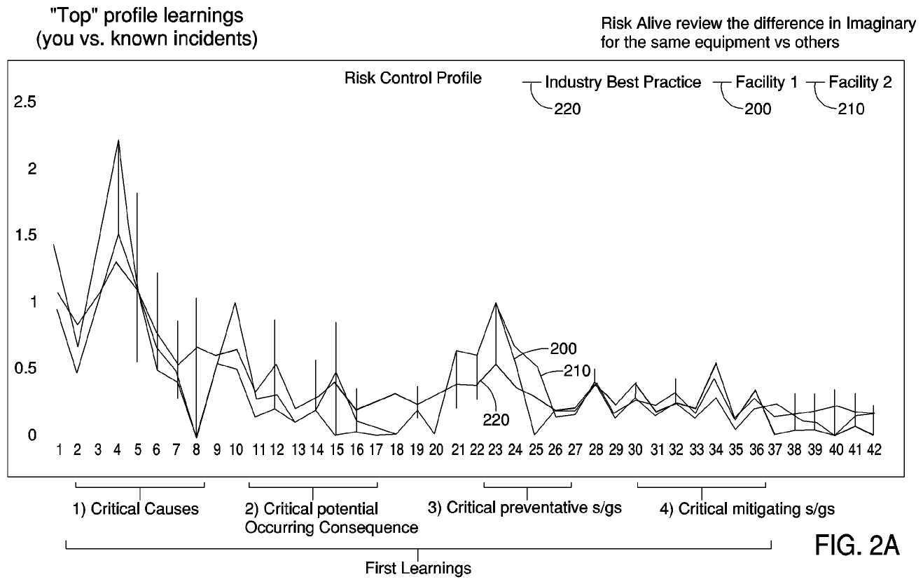

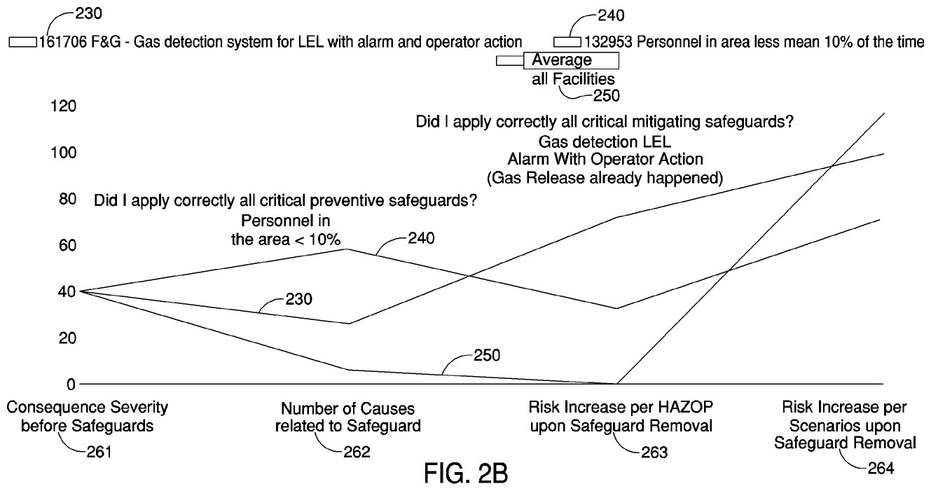

For the purpose of illustrating how Profile Learnings may be implemented to identify significant differences between a facility and the benchmark profile, a hypothetical example will be presented with reference to FIGS. 2A through 2C.

FIG. 2A illustrates a profile line graph of Facility 1 (line 200) and Facility 2 (line 210), as compared to an “industry best practice” benchmark profile (line 220). Along the x-axis of the graph, there is represented analytics 1 through 42, grouped together by the following categories: (1) Critical Causes; (2) Critical Potential Occurring Consequences; (3) Critical Preventative Safeguards; and (4) Critical Mitigating Safeguards. As may be seen in FIG. 2A, the profile lines of the Critical Mitigating Safeguards category of analytics are substantially similar to each other. However, the profile lines of the Critical Preventative Safeguards category of analytics shows significant deviations between the Industry Best Practices benchmark profile and the profiles of Facilities 1 and 2.

FIG. 2B illustrates a close-up view of a section of a profile line in a different hypothetical example, showing how analytics may be used not only to compare analytics between facilities, but also to compare analytics between particular safeguards within a facility. In this profile line, there are shown two specific safeguards of a given facility (Gas detection system for LEL with alarm with operator action, line 230; and personnel in area less than 10% of the time, line 240) as compared against a benchmark consisting of the average of all safeguards within a facility or processing unit of an operator (line 250).

As can be seen in FIG. 2B, examples of analytics relating to critical preventative safeguards include, for example, the consequence severity before safeguards (261), the number of causes related to the safeguard (262), the risk increase per hazard and operability study (HAZOP) upon safeguard removal (263) and the risk increase per scenario upon safeguard removal (264). In respect of the first analytic, the consequence severity before the safeguard is in place (261), the calculated value of the analytic is equal between each of the different safeguard types (230, 240) and the average of all the safeguards of this particular facility (250). However, it may be seen that the number of causes related to each safeguard is dramatically different, wherein safeguards 230 and 240 have a large number of causes related to them, as compared to the average of all safeguards of the operator within this facility. This may be an indication, for example, of how critical safeguards 230 and 240 are as compared to all of the safeguards, as safeguards 230 and 240 play a role in a large number of hazardous scenarios, given their relation to a relatively large number of causes. Similarly, safeguards 230 and 240 also have a large increase in risk per HAZOP upon removing those specific safeguards, as compared to the average risk increase per HAZOP upon removing all of the safeguards 250. This is a second indicator that safeguards 230 and 240 are critical, given the large impact on risk that these two safeguards each have upon their removal, as compared to the average impact on risk in removing any of the safeguards.

It will be appreciated by a person skilled in the art that this concept of creating a profile for a facility, or creating a profile for particular elements within that facility, such as specific critical safeguards, as provided in the examples above, is in no way intended to be limiting, and that the application of the concept of creating analytics and profiling a facility based on those analytics is not so limited, and may be advantageously customized to the particular needs of an operator.

Profile Learnings—Ideal Facility

Another example of how Profile Learnings may be applied, by aggregating data across facilities to improve the recommendations at a particular facility, is to perform a comparison across facilities of a particular type of processing unit (for example, an amine recovery unit), and utilize that comparison to propose an ideal facility which takes into account all of the PHA data available from all facilities containing an amine recovery unit to propose the most safety efficient performance that would include all validated learnings relating to that type of process unit (in this example, an amine recovery unit). The ideal facility may be utilized as a model for risk exposure comparison. For example, by calculating the Inherent Risk (in other words, the risk without safeguards) and the Risk reduction factor that is provided by safeguards.

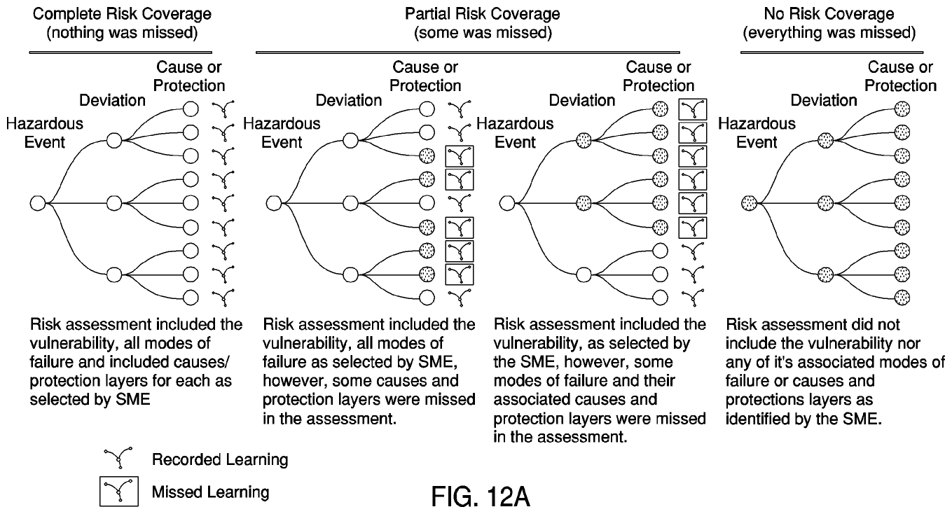

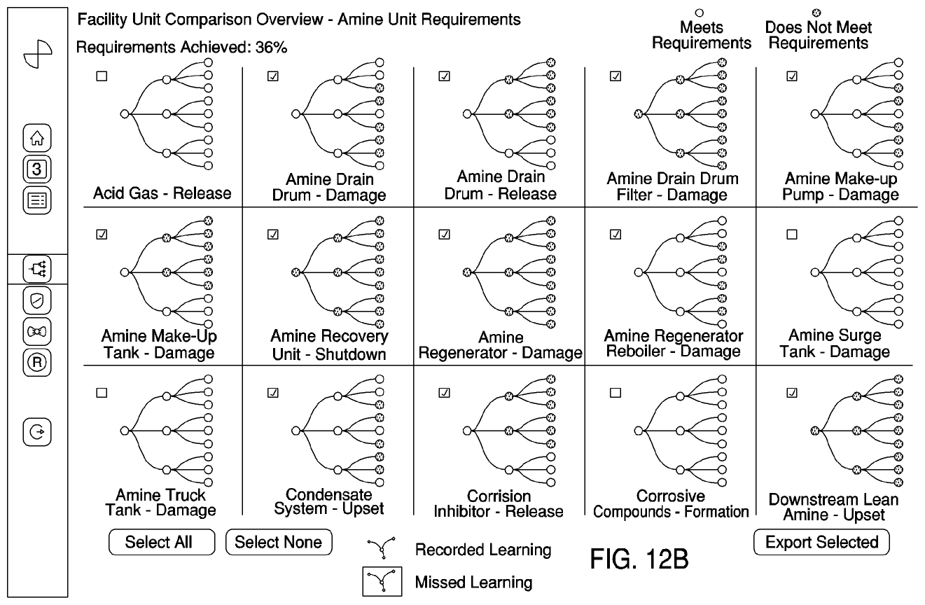

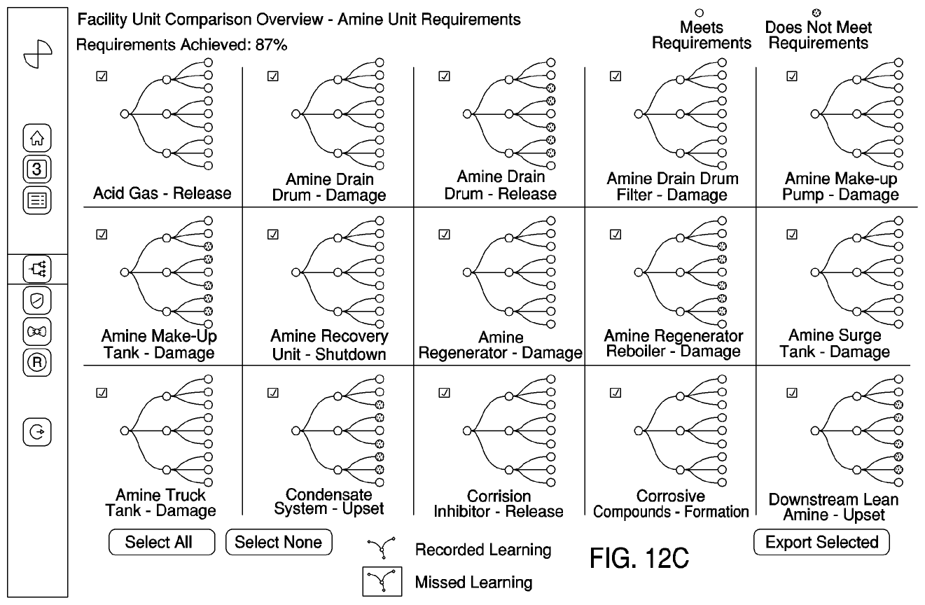

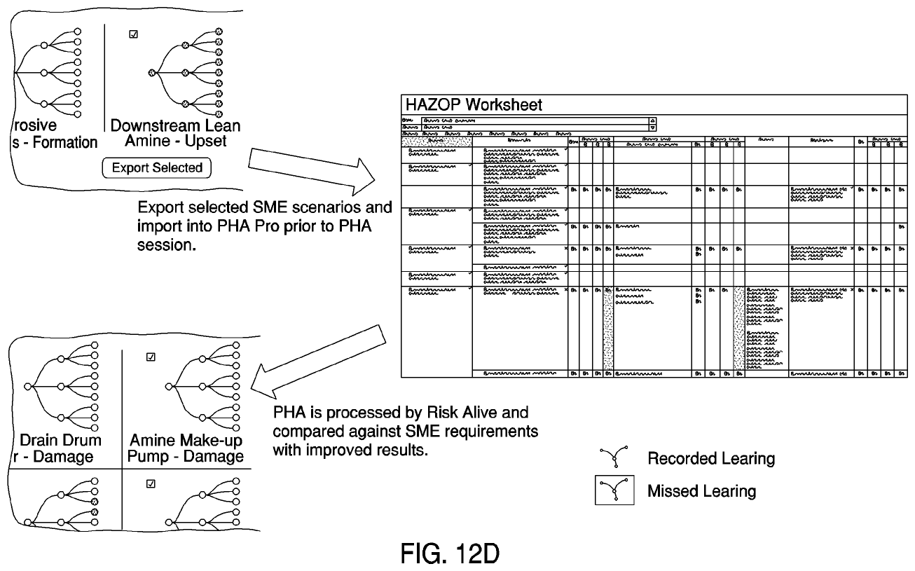

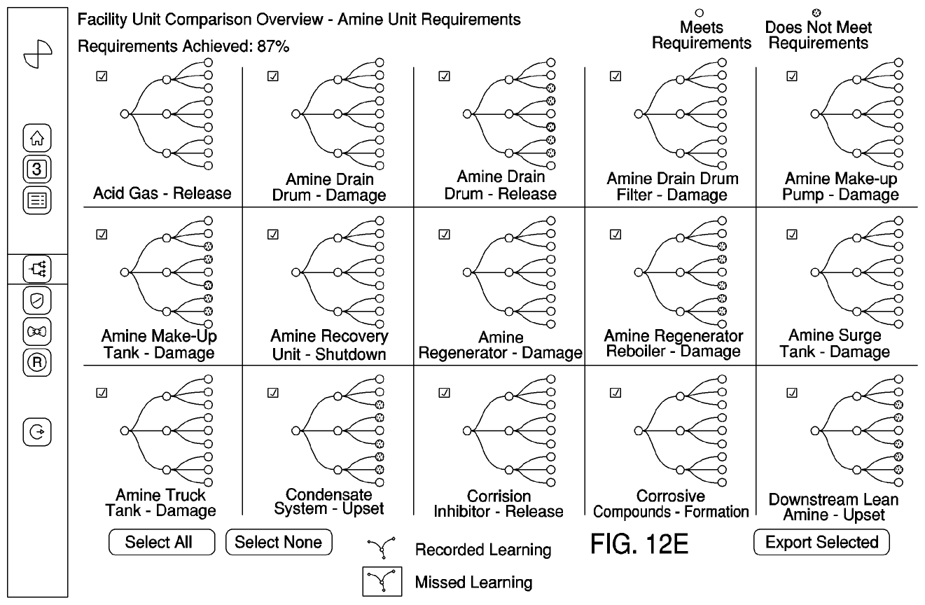

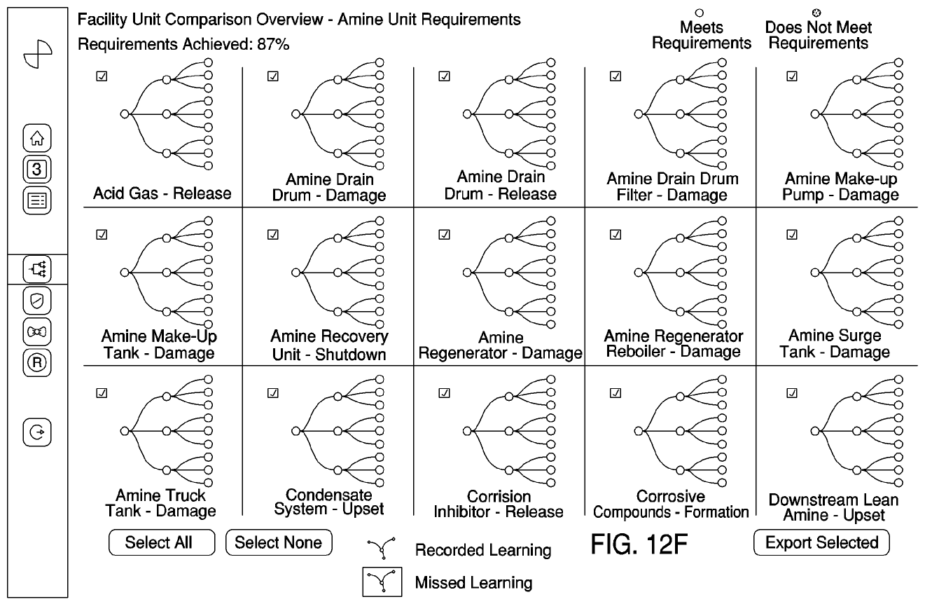

Therefore, the inherent risk of the “Ideal Facility” may be compared with any other facility's inherent risk, and thereby derive a percentage of undiscovered learnings in the target facility under review that would contribute to a percentage of inadvertent, or undiscovered, risk exposure. The use of the “Ideal Facility” model would therefore enable identification of previously undiscovered risk exposures that were not previously discovered through traditional PHA studies. For example, see FIGS. 12A-12C, showing undiscovered risk exposures in the colour red for an amine recovery unit at the facility under review. Furthermore, a measure of risk reduction required to cover this (previously undiscovered) risk exposure may be provided. For example, see FIGS. 12D-12F, showing that the previously undiscovered risk exposures (indicated in red) in FIGS. 12A-12C have now been identified in the facility under review (the previously red data elements now shown in green in FIGS. 12E-12F).

Inherent risk can be compared with any other facility inherent risk, and a percentage of undiscovered learnings that would give a percentage of inadvertent or undiscovered, risk exposure.

One example of how operational performance analytics may be used, is to utilize the PHA data of a given facility to validate the operational integrity of the safeguards that were used in a Hazard and Operability (HAZOP) study to reduce the risk of hazardous consequences, and determine the criticality of the out-of-service safeguards (in other words, by calculating the risk reduction contribution (RRC) of those out-of-service safeguards). Finally, one may determine the facility's risk exposure by comparing the risk reduction claimed in the HAZOP study to the safeguard risk reduction effectiveness and availability as determined from the historical PHA data. Furthermore, utilizing this procedure enables forecasting of the risk accumulation over time if the safeguards are not brought back into service (per the Predictability Learnings discussed elsewhere in this application).

The following are several examples of the types of performance questions that may be addressed with the assistance of profile lines or Profile Learnings. It will be appreciated that these examples are not intended to be limiting and that many other analytics may be addressed with the assistance of profile lines and Profile Learnings.

Profile Learnings—Risk Discovery

The generation of detailed profiles and analyses of PHA and LOPA data sets for a large number of facilities, as described above, requires a significant investment of time and money. For a corporation that operates many facilities in different locations around the world, it may be difficult to identify, early in the process, which facilities or operating units within facilities require immediate attention and resources, so as to mitigate a future hazardous event from occurring.

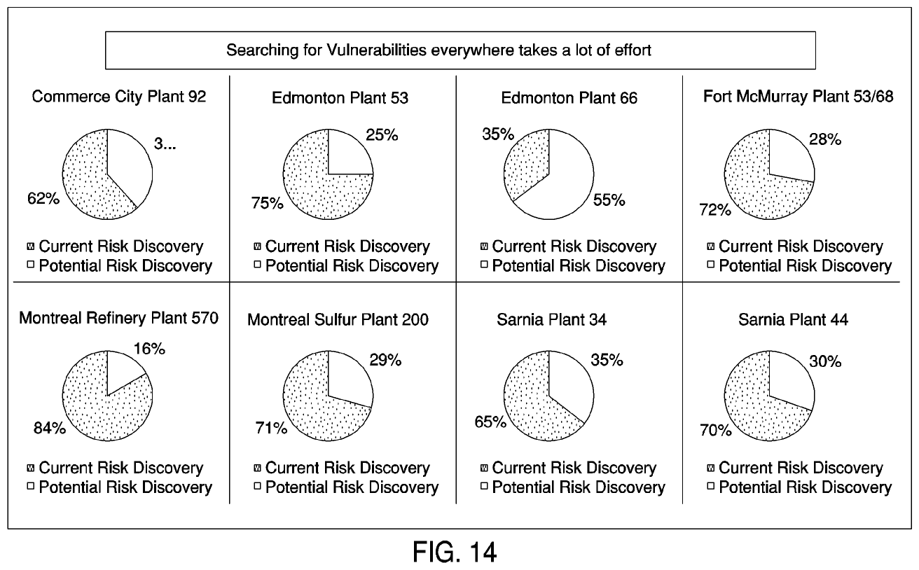

In an embodiment of the present disclosure, referred to as Risk Discovery, the Profile Learnings discussed elsewhere in this application may be utilized to readily identify a subset of the facilities amongst the many facilities of an operator that should be prioritized, with respect to timely review and implementation of recommendations to improve the safety of that facility. In turn, this enables the operator to maximize the increase in safety across multiple facilities, for a given amount of time and resources invested into improving the overall safety of that operator's facilities. The Risk Discovery of a given facility, in one embodiment, is a graphical representation of the proportion of risks that were identified for that facility, as compared to the total number of risks identified amongst a grouping of similar facilities (or processing units). For example, FIG. 14 is an example of the Risk Discoveries illustrated for a group of eight similar facilities (for example, each of the facilities share the same type of processing unit, such as a sulphur recovery unit). Each Risk Discovery chart displays the Current Risk Discovery (light shading) and the Potential Risk Discovery (dark shading). The Current Risk Discovery figure represents the percentage of risks identified for that facility, as compared to the total number of risks that were discovered amongst the group of eight similar facilities, and the Potential Risk Discovery figure represents the percentage of risks that were not identified for that facility, as compared to the total number of risks discovered across the eight similar facilities. Therefore, Risk Discovery provides an overall assessment of the thoroughness and accuracy of a HAZOP study conducted for a given facility.

In the example shown at FIG. 14, at one extreme, the Risk Discovery of Edmonton Plant 66 shows that 65% of the risks were identified at that facility, as compared to the total number of risks discovered across the eight facilities. At the other extreme, the Risk Discovery of the Montreal Refinery Plant 570 shows that only 16% of the risks were identified at that facility, as compared to the eight other facilities. Therefore, in this example, the HAZOP study conducted at the Edmonton Plant 66 accomplished identifying the most risks, while the HAZOP study conducted at the Montreal Refinery Plant 570 failed to identify most of the risks that were identified across the eight similar facilities. As a result, if all eight facilities were operated by the same entity, that entity would be advised to prioritize its resources on further investigating and improving the safeguards at the Montreal Refinery Plant 570, as the fact that only 16% of the risks were identified indicates that there may be large gaps in the hazard safety analysis and therefore, the greatest opportunity for improving safety at that facility.

As described in this disclosure, profile lines may be constructed for the different types of Learnings obtained from the conditioned PHA and LOPA data sets of a given facility or operating unit. The creation of certain profile lines, such as those based on First Learnings and Group Learnings, take relatively less time to construct, as compared to profile lines based on other Learnings.

Having processed a large volume (for example, hundreds or thousands) of data sets to derive thousands of profile lines for different facilities and processing units, the Applicant has discovered that two facilities which share similar profile lines, may also be predicted to share similar risk profiles, as illustrated by the Risk Discovery of the facility. Because of this, once initial profile lines for a given facility have been developed, by performing partial analytics on the PHA/LOPA data sets for that facility, which profile lines are based (for example) on the First Learnings and Group Learnings of the facility, by comparing those initial profile lines to the profile lines of thousands of other facilities to identify similar profile lines, one can predict with a reasonable degree of certainty that the Risk Discovery of the given facility (hereinafter, otherwise referred to as the “unknown facility”) will be similar to the Risk Discovery of the known facility having the similar profile line. Therefore, this analytical comparison enables early identification of those unknown facilities that have the greatest proportion of Potential Risk Discovery, therefore allowing an operator to prioritize further safety improvements at those identified unknown facilities.

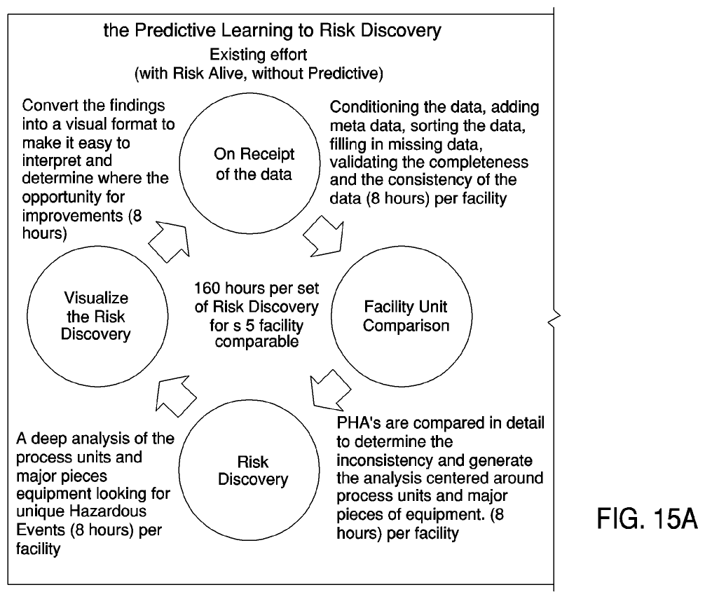

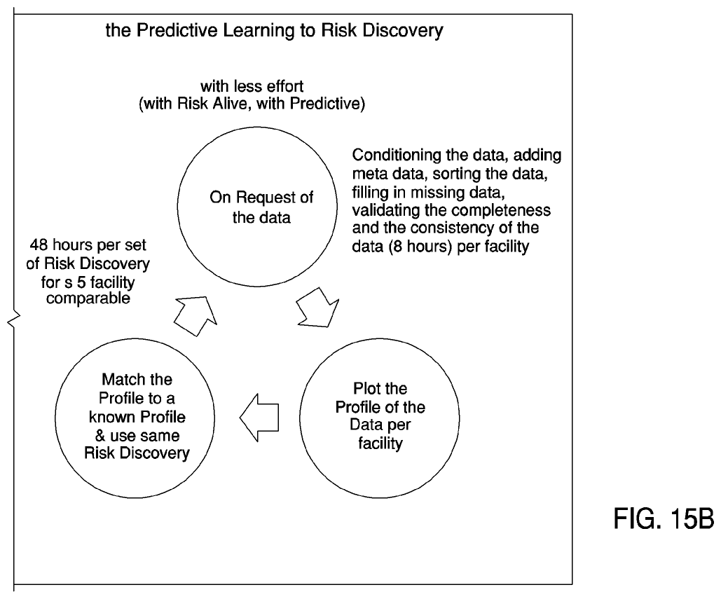

As a result, it is possible that concrete steps towards implementing new safety recommendations and safeguards at a high-priority facility may occur weeks, months or years sooner, as compared to a process whereby a full HAZOP analysis is conducted at all facilities simultaneously. The traditional HAZOP analysis approach by owner/operators may take three to five years to uncover the high risks among many different process units at one or more unknown facilities. Whereas, the new approach that is described and claimed, above, may uncover the high risks in a matter of hours or days, as the unknown facilities on which a full analytics procedure has not yet been performed. As an example, without intending to be limiting, a process for analysing the risk discovery of an unknown facility without predicting the Risk Discovery, as compared to the process for analysing the risk discovery of an unknown facility with predicting the Risk Discovery of that unknown facility based on identifying another, known facility having a similar risk profile, is illustrated in FIGS. 15A-15B.

Predictive Learnings

A prediction is a probabilistic statement that something will happen in the future, based on what is known today. A prediction generally assumes that future changes in related conditions will not have a significant influence.

Predictive Learnings based on PHA data will tell the user the probability of experiencing a hazardous event or an accident (consequence) in a given time frame. In one aspect of the present disclosure, these probabilities may be provided in at least three frames of reference: (1) with all safeguards in place; (2) with no safeguards in place; and (3) with the actual safeguard status taken into account. These three probabilities, which form the basis for Predictive Learnings, may be calculated at varying scopes; for example, the calculations may be based upon all facilities of a company or operator, or a specific facility within a company, or a specific processing unit within a facility.

More specifically, Predictive Learnings are derived from the realization that a scenario, such as a hazard scenario identified in a PHA study, has the likelihood, or probability, to occur within a given period of time, referred to as the Time to Failure (TTF). Additionally, Predictive Learnings may be based upon the observed mean time to failure (MTTF) of multiple units of a generic piece of equipment that has been in operation at a facility, which MTTF is calculated by taking the average of the observed TTF of the multiple units of equipment. MTTF may also be provided, for example, by the manufacturer of a piece of equipment and is based upon the average time to failure of several units of the equipment.

Generally speaking, the risk exposure of an incident or accident expected to occur will increase over time. As an example of how predictability based on expected time to occur (TTO) works, the example not intended to be limiting: suppose a hypothetical piece of equipment has, on average, the probability that it will malfunction once in a period of two years. That probability converts to the average probability of 50% that the equipment will fail within the first year of operation. However, if that piece of equipment operates for 23 months without malfunction, then the probability that the equipment will malfunction in the next month is very high—in the range of 95%-99% certainty, depending on the accuracy of the original TTF estimation of one malfunction in two years. Assuming that the malfunction of this piece of equipment is linked to a hazardous scenario as the initiator of the hazardous event, and that there are no safeguards in place, the likelihood of equipment malfunctioning would be equivalent to the likelihood of the resulting harmful consequence of the hazardous scenario. Thus, in the above hypothetical example, the probability of a harmful consequence occurring would be within two years of when the hazardous process was initiated (based on the assumption that there are no safeguards in place). Similarly, the probability of that harmful event would increase over time, such that after 23 months of operating the equipment without malfunction, the probability of the harmful consequence occurring in the next month would be in the range of 95%-99%.

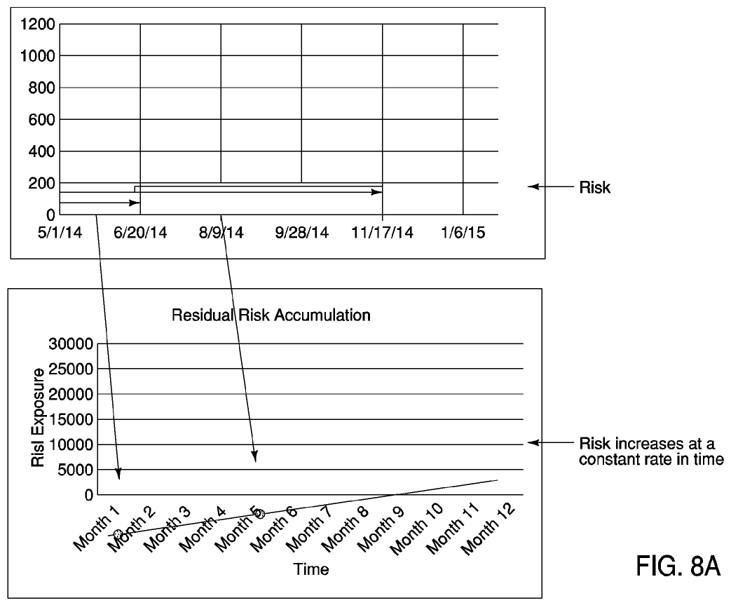

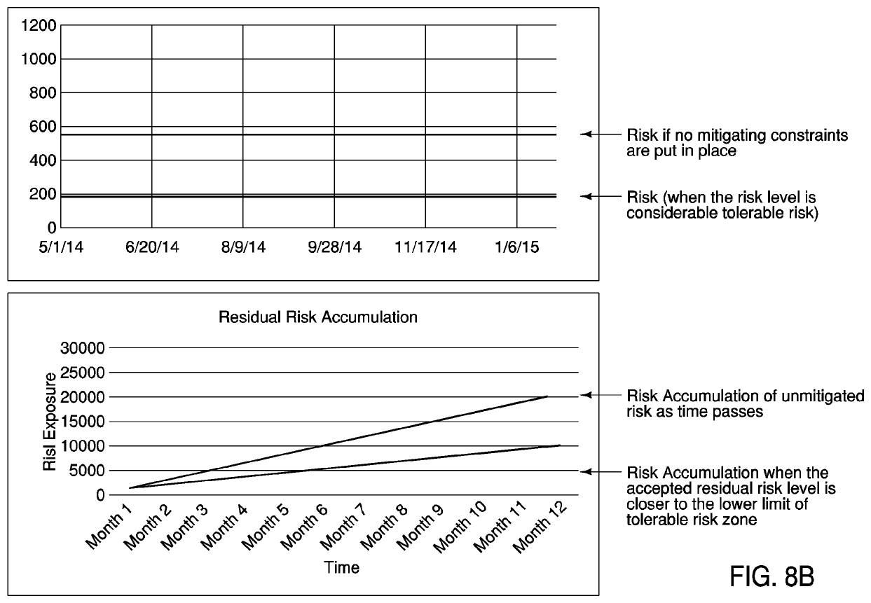

Risk exposure over time may be expressed in the following calculation; a graphical representation of the risk exposure over time is also illustrated in the graphs presented at FIGS. 8A and 8B:

Risk_{(of damage or harm)}=Likelihood×Consequence×Time Exposure Equation 2

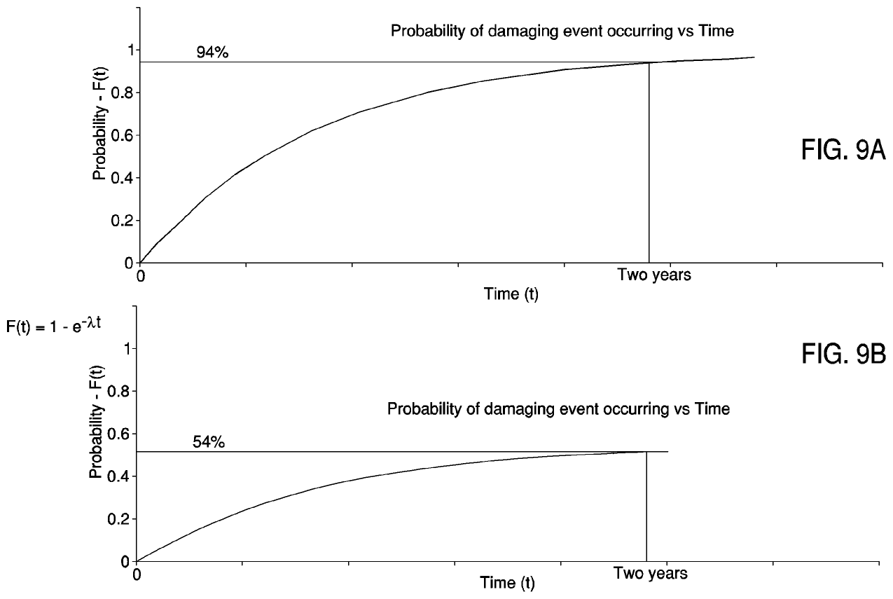

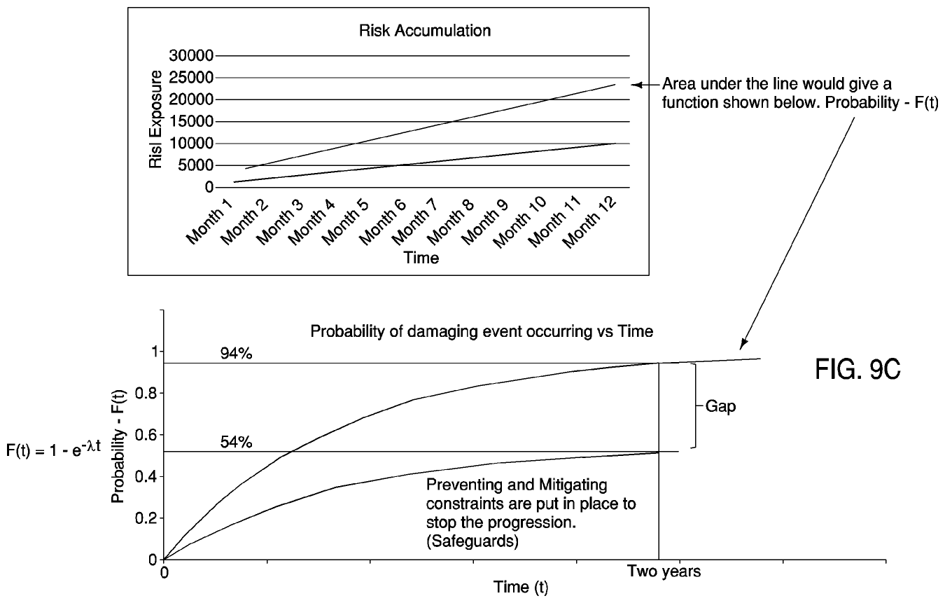

Although the risk exposure increases over time, the likelihood of a hazardous event materializing may be reduced by the use of preventing constraints (safeguards) to stop the release of potentially damaging energy; and additionally reduced by the use of mitigating constraints to minimize or reduce the uncontrollable release of potentially damaging energy. The use of such safeguards (in other words, preventing constraints and mitigating constraints), may sufficiently lower the risk exposure to a tolerable level. For example, see FIGS. 9A-9C, which presents a graphical representation of the impact that safeguards may have on the probability of a hazardous or damaging event occurring over time. Keeping with the example of a hypothetical scenario involving a system of multiple pieces of equipment working together within the system, the hypothetical scenario having an expected time to occur (TTO) of two years, FIG. 9A shows the probability of equipment failure leading to a damaging event after 23 months of operation without any malfunction, rises to 94% in the absence of safeguards. However, FIG. 9B shows that, by implementing safeguards, the probability of equipment failure leading to a damaging event after 23 months of operating without any malfunction, drops to 54%. FIG. 9C shows that the relationship between the risk exposure and the probability of a hazardous event occurring are related; namely, the area under the curve of the risk exposure vs. time graph results in the probability vs. time graph.

Predictability Learnings—Detailed Calculation of a Hypothetical Example

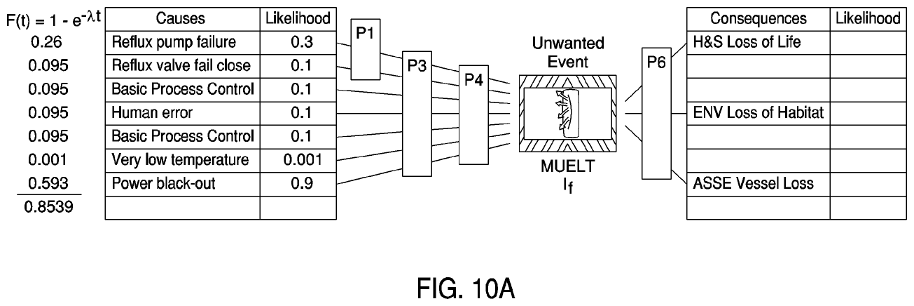

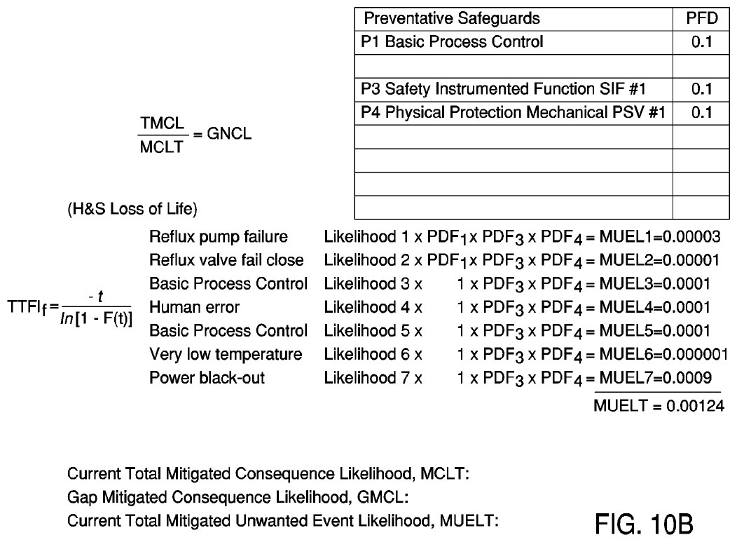

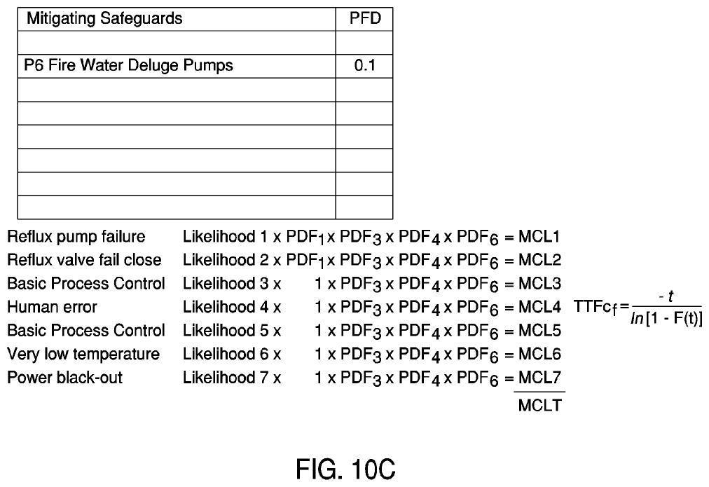

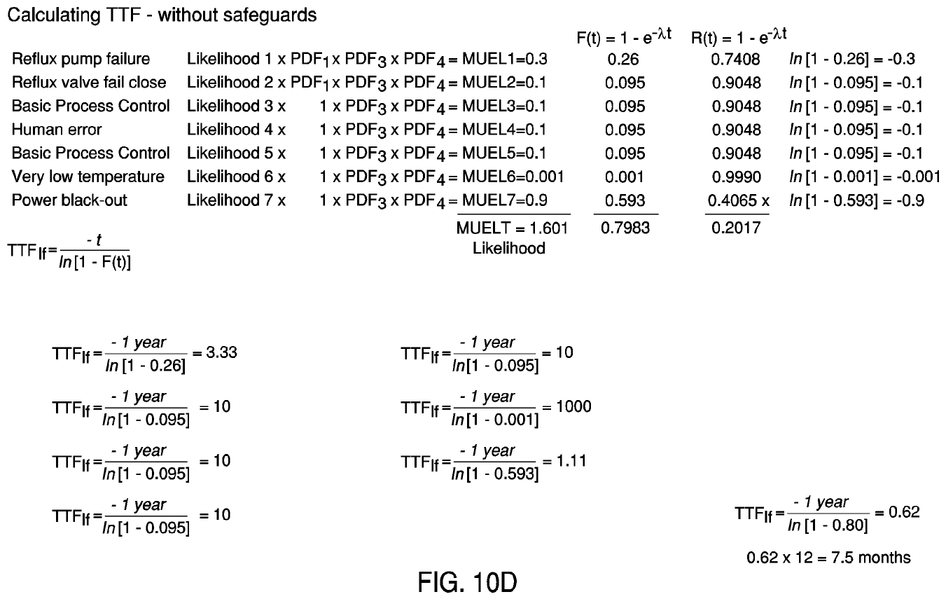

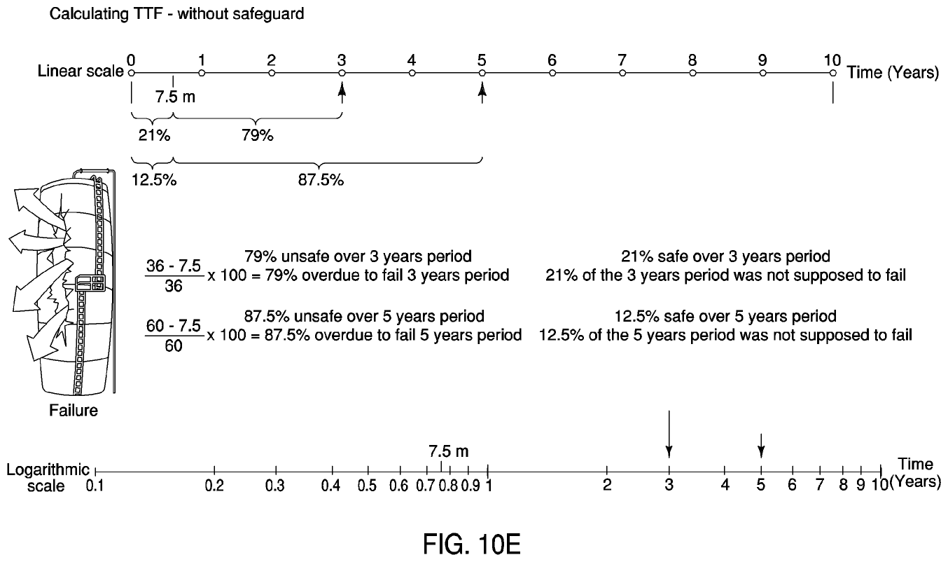

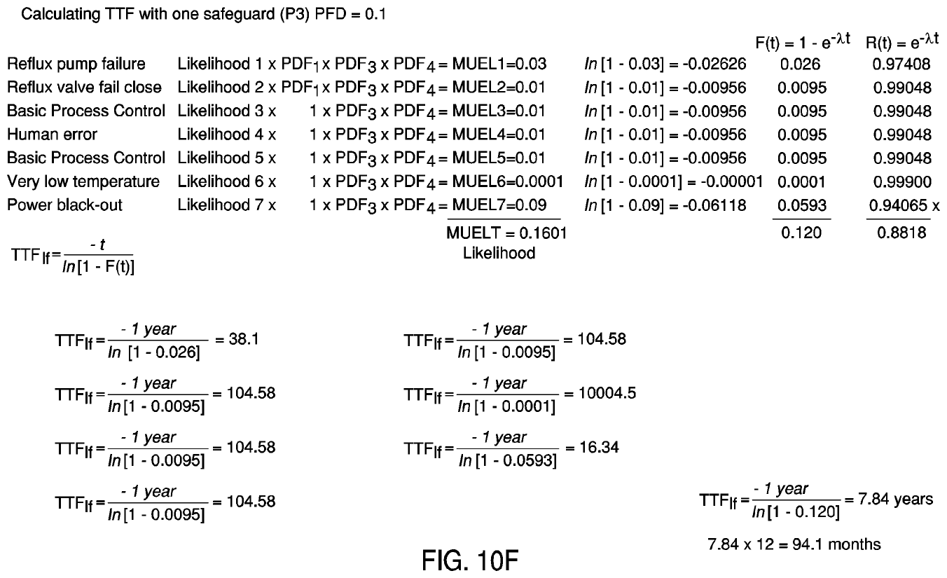

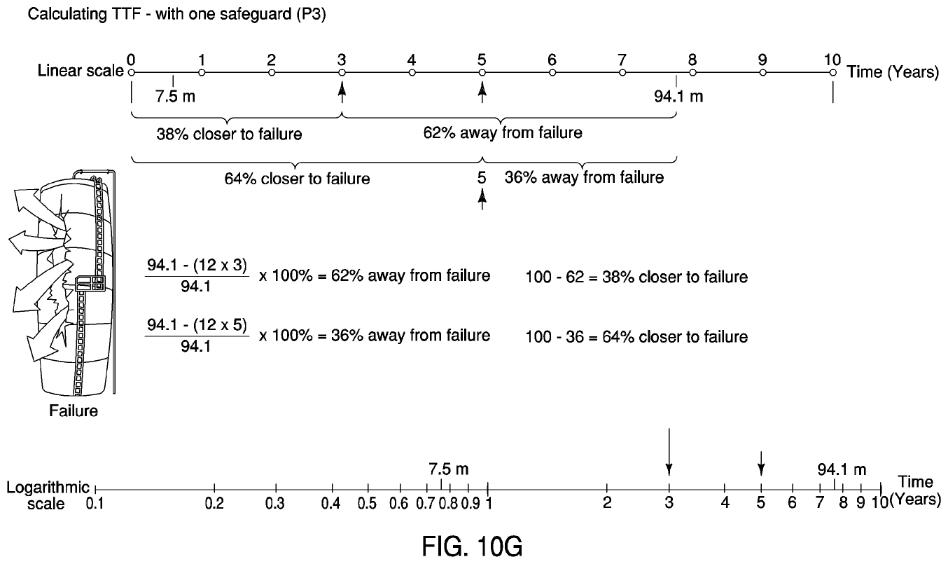

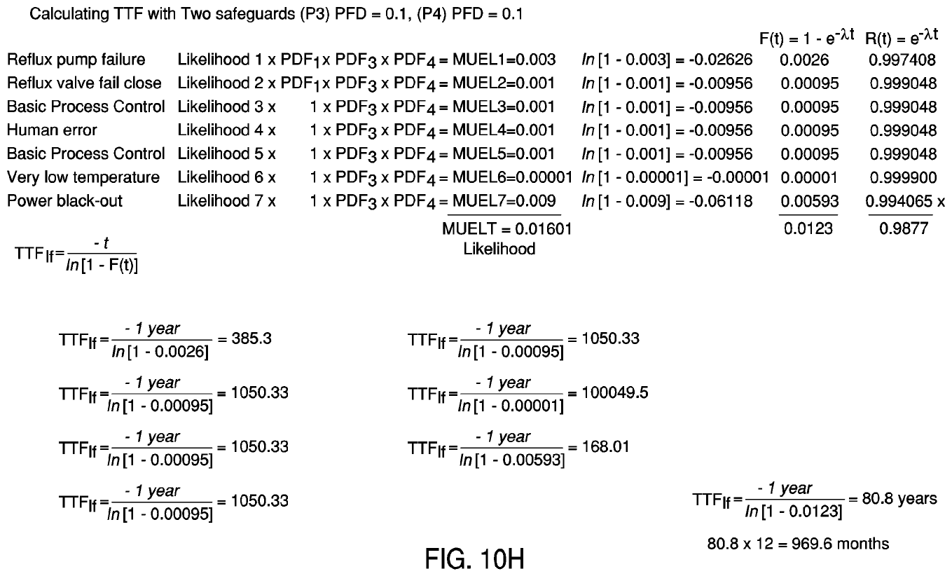

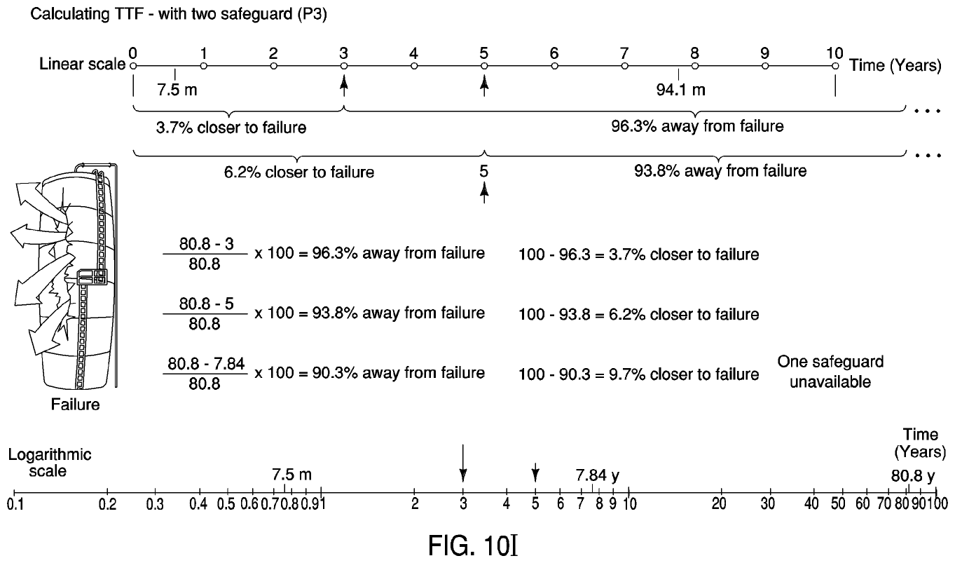

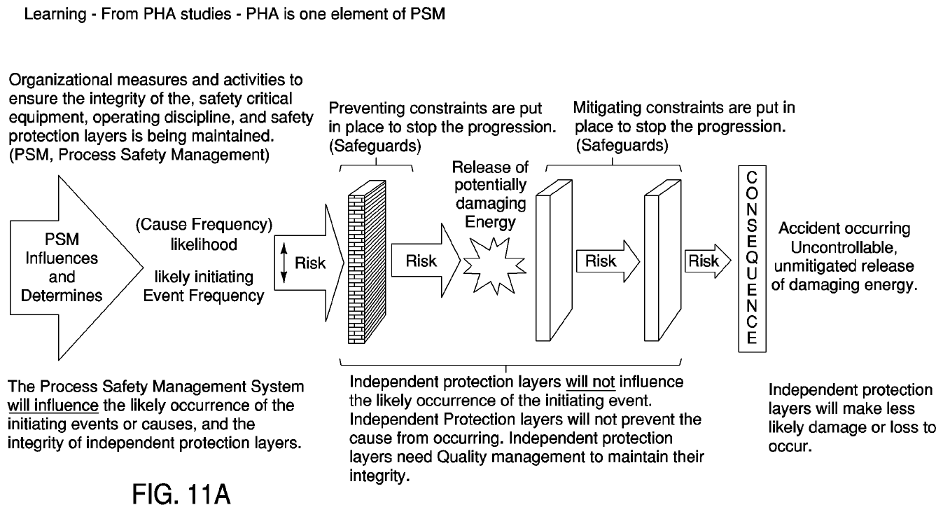

FIGS. 10A through 10I provide a detailed example of how the probability of a hazardous event may be calculated, taking multiple safeguards into account. As illustrated in FIG. 10A, a hazardous scenario is illustrated in a bowtie diagram, showing seven different possible causes (reflux pump failure, reflux valve fails to close, two different problems with basic process control, human error, very low temperature and power black-out) and the likelihood of each cause occurring, leading to an unwanted event. Preventative safeguards P1, P3, P4 and P6 are also illustrated on the bowtie, and the probability of failure on demand (PFD) for each safeguard is also provided. The Current Total Mitigated Unwanted Event Ukelihood (MUELT) is calculated by multiplying the likelihood of each cause by the PFD of each safeguard related to that cause, to derive the current mitigated unwanted event likelihood of that particular cause (MUELX, where X=1 to 7), and then MUELT is arrived at by adding the seven MUEL figures together.

On the other side of the bowtie, the Current Total Mitigated Consequence Likelihood (MCLT) is similarly calculated by calculating the individual mitigated consequence likelihoods of causes 1 through 7 (MCL1 through MCL7), and then adding each of those values to derive MCLT (total). However, in this case, the PFD of each safeguard that mitigates a particular cause, as well as the PFD of the safeguard mitigating the particular consequence, is included in the calculation of MCL1 through MCL7.

The calculated MCLT and MUELT values are then used to calculate the probability of occurrence function, or F(t), as follows:

F(t)=1−e^{-λt} Equation 3

Where λ is the failure rate (for example, how often does the piece of equipment fail per year?) and t is the reference time period on which the rate of failure is based (for example, one year). From this function, the expected time to failure (TTF), when referring to a single component in the system, or expected time to occur (TTO), when referring to the subsystem of a scenario including multiple pieces of equipment working together in the subsystem, is calculated as follows:

TTF=−t/(ln [1−F(t)]) Equation 4

As shown in FIG. 10D, the TTF is predicted to be 7.5 months, assuming that none of the safeguards are in place. Applying this calculation to a selected time interval of, for example, three years, as shown in FIG. 10E, it may be predicted that over the selected time interval of three years, assuming no safeguards in place, we can predict that the hazardous event may occur in 7.5 months, which means that 79% of the three year period we can expect the exposure to the risk of this particular hazardous event to be a high exposure.

Referring now to FIG. 10F, we can apply the same set of calculations to a scenario where one of the safeguards (safeguard P3) is in place, so as to see the impact on the predicted expected time to occur (TTO) for the hazardous event to occur. Indeed, the addition of the one safeguard (P3) changes the predicted TTF to a period of 94.1 months, or 7.84 years. As shown in FIG. 10G, we can see that selecting a time interval of 3 years yields the result of being 38% closer to a predicted failure, at the three year mark, because the predicted TTF of 7.84 years exceeds our selected time period of 3 years. Even selecting a different time interval, for example 5 years, provides us with the result of being 64% closer to the predicted time of failure (TTF) because the predicted TTF of 7.84 years still exceeds our selected time interval of 5 years. In other words, it may be easily seen that adding one safeguard (P3) has the impact of greatly extending the predicted TTF, from 7.5 months to 94.1 months, thereby greatly reducing the exposure to risk over a selected time interval, of say three years or five years. Similarly, running the same calculations with two safeguards in place (P3 and P4), as shown in FIG. 10H, yields the result that the predicted TTF is extended to 969.6 months or 80.8 years, which is a further, significant reduction in exposure to the risk of the hazardous event occurring over either of the selected time intervals of three years or five years.

In summary, Predictive Learnings provide organizations the ability to view their risk on the aggregate, so as to determine whether they are getting “closer to,” or “farther from,” an incident or accident. This knowledge may assist facility operators in becoming more aware of current risk levels at a facility, and thereby change the behavior of site personnel appropriately, based on the presently assessed risk level of the facility. Continuous feedback obtained from Predictive Learnings, and response to that feedback, may result in better understanding, by leadership and management, of the organization's structure within the facility and the interactive dynamics between them. When the facility system and subsystems have received sufficient feedback, the results can produce more clearly directed planning, intelligent design, useful products and necessary services.

Group Learnings

First Learnings do not always provide a comprehensive risk picture of the total risk associated with several hazardous scenarios that share a common hazardous event and consequence severity. The applicant has discovered that by grouping together two or more hazardous scenarios, represented by bowties, which share a common hazardous event and consequence severity, it is possible to obtain a more comprehensive analysis of the level of risk associated with a particular area—for example, a processing unit within a facility. This relational attribute of the grouping of two or more hazardous scenarios is referred to herein as a “grouped representation,” and may also be referred to as “Group Learnings” by the Applicant.

Firstly, grouping hazardous scenarios may be visualized by creating a “bowtie” diagram, which is a visual representation of the causes, consequences, safeguards, conditional enablers and modifiers relating to a same consequence and hazardous event. The criteria for constructing a bowtie includes identifying the multiple causes or initiating events leading to the same hazardous event, in same geographic area (within a facility or in the same process unit, for example), affecting the same location of interest and having same category consequence severity. Once the data elements meeting the above criteria are identified as leading to a given hazardous event and consequence, the bowtie is completed by identifying the safeguards, conditional enablers and modifiers which may impact that hazardous event and consequence flowing from that hazardous event.

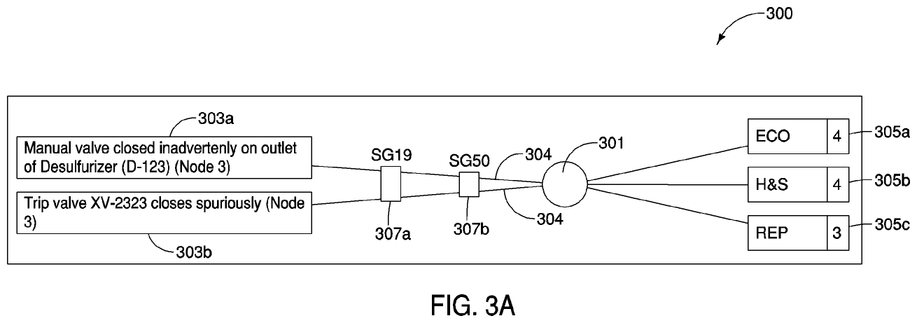

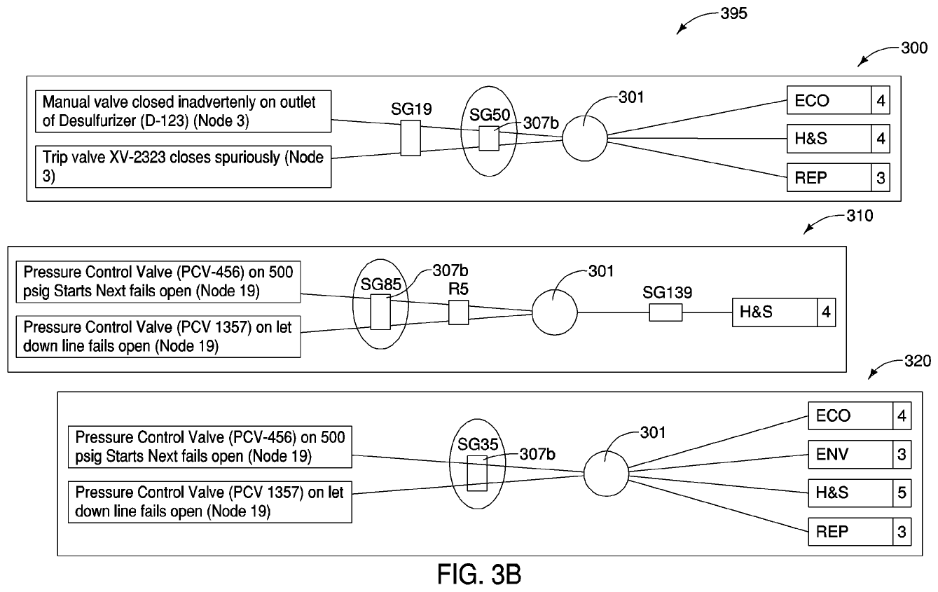

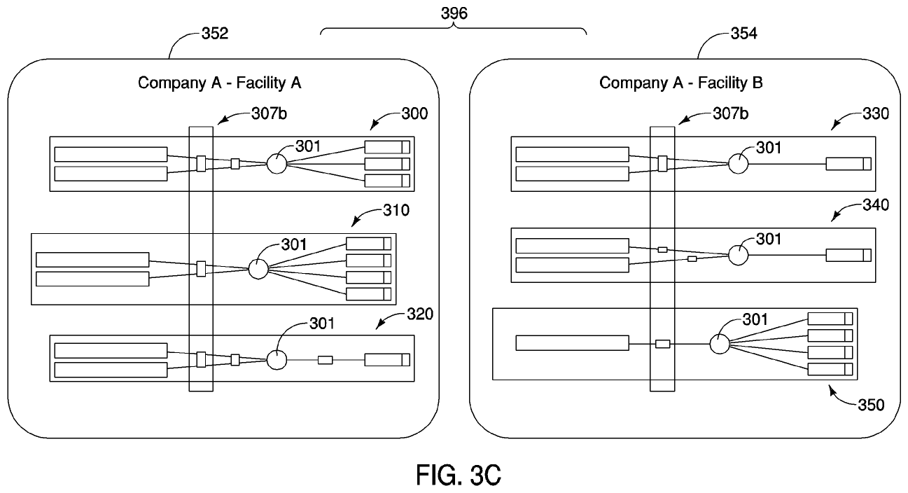

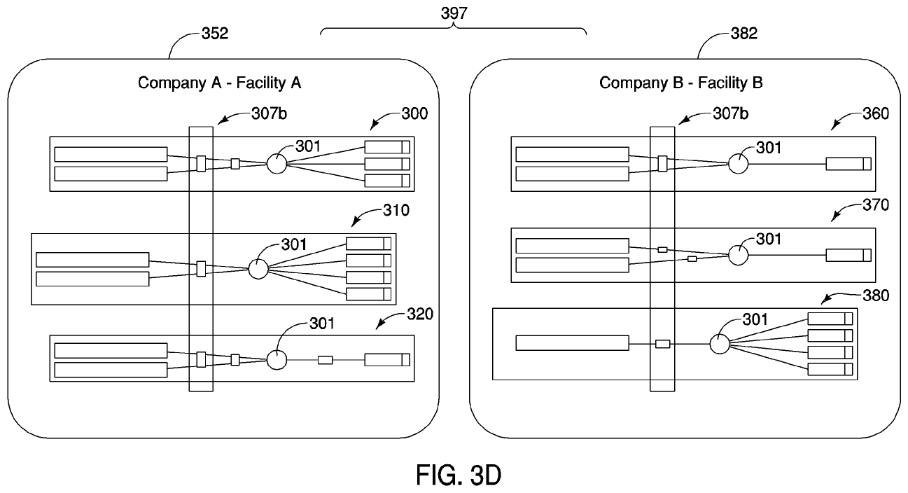

An example of a bowtie 300 is illustrated in FIG. 3A. In this particular example, two potential causes 303a, 303b, and three potential consequences 305a, 305b and 305c are identified in respect of hazardous event 301. Additionally, two safeguards 307a, 307b are identified as potentially preventing the causes 303a, 303b from initiating the hazardous event 301. Although in this example, the safeguards 307a, 307b are shown as each potentially preventing the causes 303a, 303b from initiating the hazardous event 302, as illustrated by crossing the lead lines 304, 304 extending between the cause 303a or 303b and the hazardous event 301, it will be appreciated that not all safeguards will be relevant to preventing all causes from initiating a hazardous event or mitigating all consequences of a hazardous event 301.

In FIG. 3B, an example of a grouped representation 395 is illustrated. In this example, the hazardous scenario represented by bowtie 300 is grouped together with the hazardous scenarios represented by each of the bowties 310 and 320, because each of the bowties 300, 310 and 320 relate to the same hazardous event 301, and each shares a common data element; specifically, safeguard 307b. Although the common data element in this example and the examples illustrated in FIGS. 3B-3D is a safeguard, grouped representations may be based upon other categories of common data elements; for example, a shared cause or a shared consequence. In this particular example, the bowties 300, 310 and 320 represent hazardous scenarios existing in the same physical location of reference, such as a single facility equipment area.

In FIG. 3C, another example of a grouped representation 396 is illustrated. In this example, hazardous scenarios represented by bowties 300, 310, 320, 330, 340 and 350 are grouped together because each of these bowties relate to the same hazardous event 301, and each shares a common data element; specifically, safeguard 307b. This time, the bowties 300, 310 and 320 represent hazardous scenarios existing in one physical location, namely Facility A 352 of Company A, and the bowties 330, 340 and 350 represent hazardous scenarios existing in another physical location of the same operator; namely, Facility B 354 of Company A.

In FIG. 3D, a further example of a grouped representation 397 is illustrated. In this example, hazardous scenarios represented by bowties 300, 310, 320, 360, 370 and 380 are grouped together because each of these bowties relate to the same hazardous event 301, and each shares a common data element; specifically, safeguard 307b. This time, the bowties 300, 310 and 320 represent hazardous scenarios existing in one physical location, namely Facility A 352 of Company A, and the bowties 360, 370 and 380 represent hazardous scenarios existing in another physical location of a different operator; namely, Facility A 382 of Company B.

The grouped representations may permit further study and a more detailed risk analysis and assessment, resulting in the generation of recommendations that may lower the overall risk of a hazardous scenario occurring and causing an accident. The outputs from the First Learnings, for example, may include: the risk ranking of the consequences of each identified cause of a process deviation; the existing safeguards; and recommendations to lower the risk to a tolerable level. A Group Learning study may be conducted, however, to further assess the adequacy of the Safety Protection Layers (SPLs) or safeguards that are in place to mitigate against hazardous events relating to process hazards; identify those SPLs or safeguards that do not meet the required risk reduction for a particular hazard; and make reasonable recommendations where a hazardous scenario has a residual risk that requires further risk reduction. In general, a Group Learning study may be performed when the qualitative analysis and risk assessment of the identified first learnings outputs shows the scenario to be complex or the potential consequences are severe (in other words, classified as “high risk”). Specific examples of criteria that may trigger a grouped study of a group of hazardous scenarios includes, but is not limited, to the following:
The same safeguard is deployed in multiple locations;
The severity of a consequence of a given hazard scenario is classified as having a severity of S4 or S5 (on a scale of S1-S5, wherein S5 represents the most severe consequence)
The risk ranking assigned to the hazardous scenario is categorized as 3 (orange), 4 (red) or worse, after the safeguards have been implemented
Any hazardous scenario where there are no existing safeguards, and the risk level is 2 (yellow) or with a severity of S5.

Group Learning Study—Calculations

After identifying the hazardous scenarios to be the subject of a grouped study, the group study may proceed by the following steps:
1. Identify causes or initiating events
2. Determine a frequency (per year) for each initiating event
3. Identify protection layers (safeguards)
4. Determine a probability of failure on demand (PFD) for each independent protection layer (“IPL” or safeguard)
5. The mitigated frequency (MF) for each initiating event is then calculated by multiplying the frequency (of the initiating event) by the PFD of each independent protection layer (safeguard)
6. The total MF for all initiating events is then calculated by summing the individual MFs
7. Compare total MF with tolerable frequency (TF)
8. If the MF is higher than the TF, then make recommendations to mitigate unacceptably high MF

The calculations are as follows:

$$\begin{matrix}{f}_{i}^{C} = {f}_{i}^{1} \times {\prod }_{j = 1}^{I} {PFD}_{ij} \\ = {f}_{i}^{1} \times {PFD}_{i 1} \times {PFD}_{i 2} \times … \times {PFD}_{ij}\end{matrix}$$

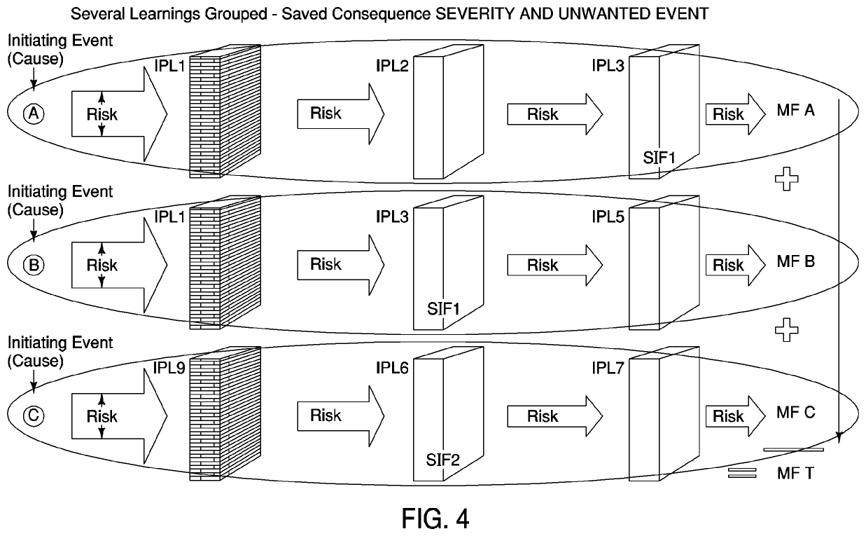

In summary, the mitigated frequency is essentially a calculation of the frequency of a consequence “C” for an initiating event “I”, taking into consideration the probability of failure on demand (“PFD”) of each safeguard that may either prevent the cause from initiating the hazardous event, or which may otherwise mitigate the severity of the consequence after a hazardous event has occurred. In other words, the mitigated frequency (MF) is equal to the frequency for consequence C for initiating event i (fᵢ^{C}) in the Equation 5 above. A visual representation of calculating the total mitigated frequency (MF_{T}) for a grouped representation is shown, for example, in FIG. 4.

Having created a relational database, containing processed PHA data in the form of what is referred to as “First Learnings” and “Group Learnings”, as described above, additional data analytics processes may be applied to the relational database to obtain further insights into the present or future safety status of a given facility, and additional safeguards that may be required to reduce the probability of a hazardous event occurring.

Ranked Learnings

During a PHA study, the team is responsible for assessing the process risk originating from various process deviations or upsets and determining the consequence and severity of potential accidents; in other words, assessing the risk of the identified cause-consequence pairs. However, resulting data sets can include hundreds or thousands of hazard scenarios, and due to the nature of the data, it is very difficult for process safety engineers to identify the most critical elements (for example, the most critical causes or safeguards). Without the ability to identify the most critical elements in the results of a PHA study, the process safety engineer may not effectively prioritize allocation of resources towards implementing recommendations so as to effectively and efficiently manage the risk. Criticality assignments are dependent on the point of reference indicated for the element; criticality may be also obtained from first learnings. For example, criticality obtained from first learnings scenarios are with respect to the entire facility, while criticality obtained from Group learnings scenarios are with respect to a subset of scenarios of the entire facility.

“Ranked Learnings” provides a solution to this challenge, by identifying the most critical causes, safeguards, recommendations and hazardous scenarios of the PHA study. Such insights may be utilized by a facility operator to prioritize maintenance, audit, and implementation of new safeguards (to the extent such action items are applicable).

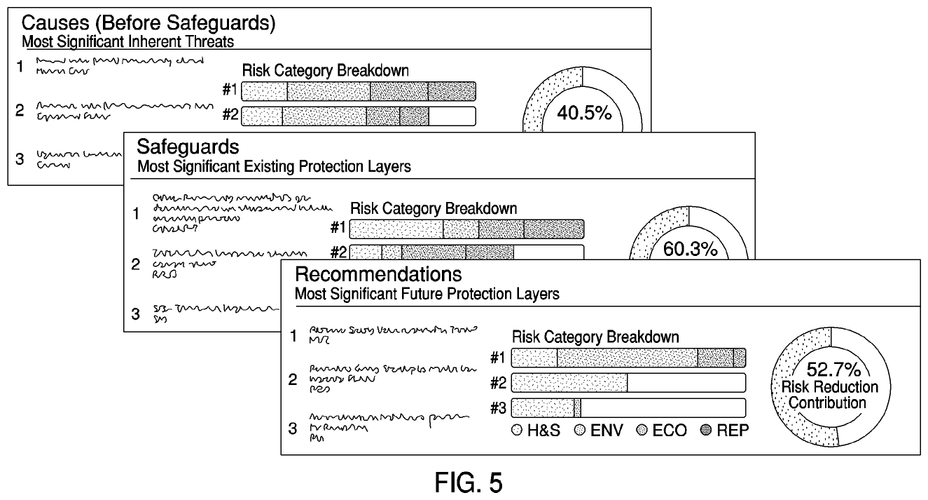

An example of a Ranked Learnings output, without intending to be limiting, is illustrated in FIG. 5. In that example, Ranked Learnings may appear in the form of prioritized lists, such as a “Top 3 Critical Causes”, “Top 3 Critical Safeguards (Existing)” and “Top 3 Critical Recommendations” (Future Protection Layers). It will be appreciated by a person skilled in the art that this example of an output is not intended to be limiting; for example, greater or fewer than three “most critical” elements may be displayed on the output list of critical elements.

Each data element within a category (for example, safeguards, causes or consequences) may be ranked and prioritized by using algorithms which are based on the client's risk matrix probabilities of occurring, and other factors. In some embodiments, in addition to ranking the individual data elements of a given category in a PHA data set, the calculations may also be extended to groups of elements, such as a hazardous scenario represented in a bowtie diagram. In this case, all individual data elements of a single bowtie contribute to a criticality calculation, producing a risk-ranked list of the most critical bowties for a given PHA scope (for example, within a particular facility, or across all facilities of an operator).

More specifically, in one aspect of the present disclosure, hazardous scenarios (represented by bowties) may be ranked in terms of criticality, by firstly determining the cumulative risk contribution of all causes leading to the same hazardous event, for the same category of consequence severity, without taking into consideration any safeguards (in other words, calculating “Bowtie Criticality without Safeguards”). Secondly, the cumulative risk contribution of all causes leading to the same hazardous event, for the same category of consequence severity, is calculated with taking into account the presence of safeguards; for example, the safeguards presently in place (in other words, calculating “Bowtie Criticality with Safeguards”). Finally, the cumulative risk contribution of all causes leading to the same hazardous event, for the same category of consequence severity, is calculated with taking into account the presence of safeguards and recommendations (in other words, calculating “Bowtie Criticality with Safeguards and Recommendations”).

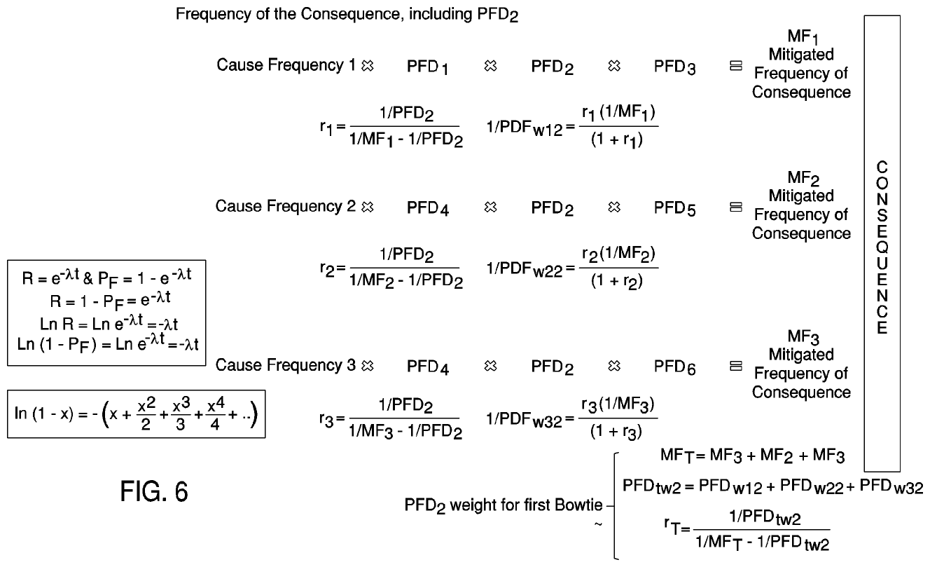

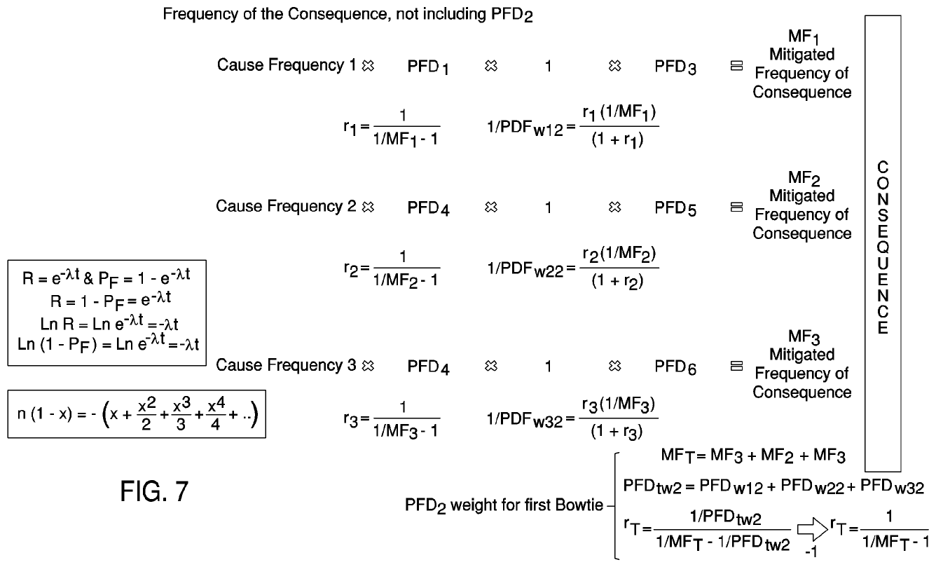

As an illustrative example of how these sets of bowtie criticality calculations may be applied, refer to FIGS. 6 and 7, which provide a calculation of the rate of mitigating risk reduction of a particular safeguard (or independent protection layer) compared to the total mitigating risk reduction (r). In FIG. 6, the frequency of a consequence is calculated where a safeguard, having a probability of failure on demand PFD₂, is included in the calculation. In FIG. 7, the frequency of the same consequence as in FIG. 6 is calculated, except that this time the safeguard, having a probability of failure on demand PFD₂, is excluded from the calculation. A risk reduction gap (“RRG”), which indicates the effectiveness of a safeguard with respect to effectively mitigating the frequency of a consequence, is calculated by subtracting the frequency of a consequence (fᵢ^{C}) without implementing the safeguard from the frequency of a consequence with implementing the safeguard (f′ᵢ^{C}). The equation for calculating RRG is as follows:

$$RRG = {\sum }_{i = 1}^{I} {f}_{i}^{C} - {\sum }_{i = 1}^{I} {f}_{i}^{′ C} \qquad Equation 6$$

In other words, the bowtie criticality calculations described above provide for determining the criticality of each safeguard in a given hazardous scenario. Having assigned a value to “how much” the risk of a consequence occurrence is reduced by the presence of a particular safeguard provides a facility operator with the ability to prioritize those safeguards which have the largest RRG, or in other words, the greatest impact on reducing the probability that a given consequence will occur.

Real Cost Learnings

“Real Cost Learnings” are insights related to safeguards, which may be quantified by the amount of risk reduction provided by the safeguard, and compared to the actual cost of that safeguard. Therefore, a return on investment (“ROI”) factor may be derived using the relation between a risk reduction factor of the safeguard and other “capital and operational cost factors” of the safeguard. The scope of consideration for these risk-based metrics may be, for example, based on a process unit, a facility, or across all facilities of a particular operator, for example (not intended to be limiting).

The Real Cost Learnings may assist a facility manager in making decisions as to where capital should be allocated, and also in which areas spending should either be increased or decreased so as to maximize the value obtained for every dollar spent on process safety measures. The core concept in “Real Cost Learnings” is that risk and financial data may be combined to create a relation which assists organizations in managing their capital and operational resources efficiently.

Specifically, in one aspect of the present disclosure, a “Risk Reduction Effectiveness” (RRE) value is a cost control solution measure with respect to mitigating effective frequency reduction of a consequence. RRE is a measure of the cost of a risk reduction control solution (such as a safeguard or recommendation) per unit of mitigating frequency reduction.

Referring above in Equation 6 to the calculation of the risk reduction gap (RRG), it may be seen below, in Equation 7, that RRE is calculated:

$$R R E = \frac{S}{R R G} \qquad Equation 7$$

Wherein, “S” is the annualized cost of a risk reduction solution (such as a safeguard or a recommendation).

In other words, reducing the probabilities of occurrence of a hazardous event and its associated consequences (such as a harm or loss), may be appraised in terms of real monetary value or by using the “utility function,” which is calculated above as the Risk Reduction Effectiveness, or RRE.

There is a relationship between the cost due to a consequence flowing from a hazardous event, (in other words, the cost of a loss), and the cost for controlling or reducing the risk of that consequence occurring.

Observing the relation between the cost required to control the risk and the level of risk reduction achieved enables reaching a decision whereby some residual risk may be accepted.

Reviewing Equation 8 below, a cost benefit analysis may be arrived at by appreciating that there is a cost to implementing a safeguard (ie: capital expenditure and operating costs), as well as a benefit to implementing a safeguard (ie: when a control solution is successful in preventing a hazardous event from causing harm or loss; the potential monetary hypothetical loss may be considered a gain or benefit, in the calculations below):

$$Equation 8$$

$$Ratio of Cost to Benefit = \frac{\begin{matrix}Capital Cost of added IPL + \\ [ \begin{matrix}Operational Cost \\ of added IPL \text{/} year\end{matrix} * \begin{matrix}Anticipated future \\ useful life of IPL ( years )\end{matrix} ]\end{matrix}}{\begin{matrix}Anticipated future useful life of IPL ( years ) * \\ [ \begin{matrix}Value of avoided loss \\ prevented by IPL\end{matrix} * \underbrace{( \frac{1 / PFD}{1 / MF - 1 / PFD} )}_{r} ]\end{matrix}}$$

Wherein, IPL is an independent protection layer, otherwise referred to as an independent safeguard.

System

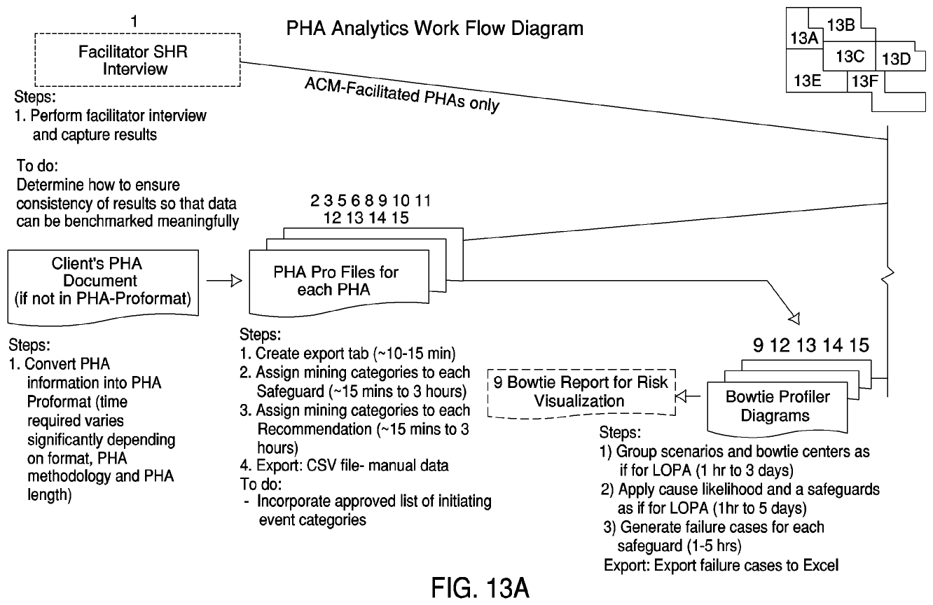

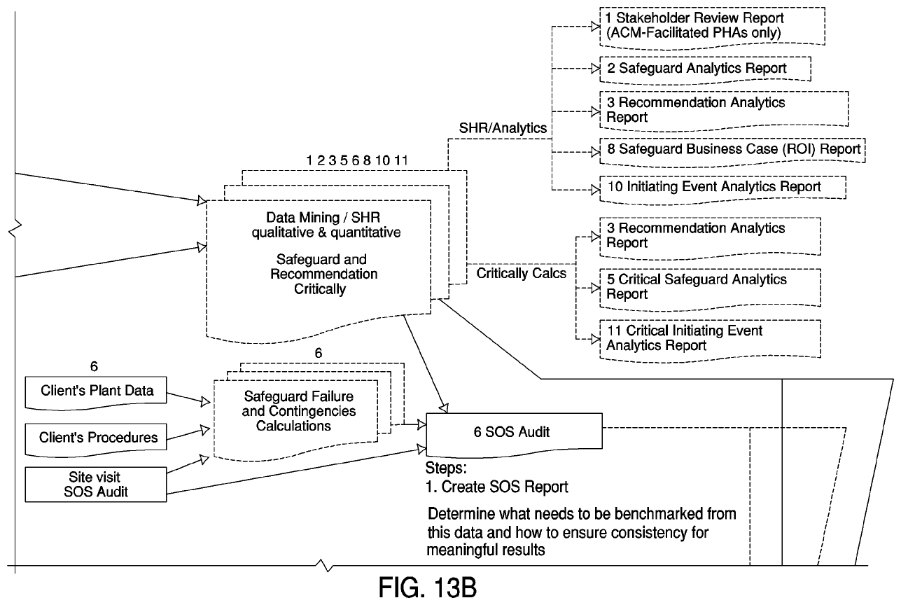

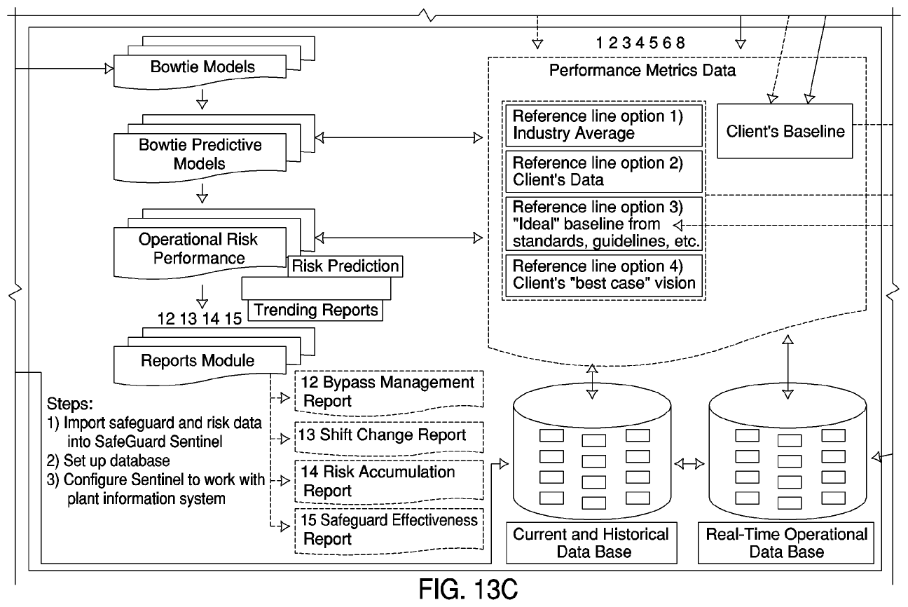

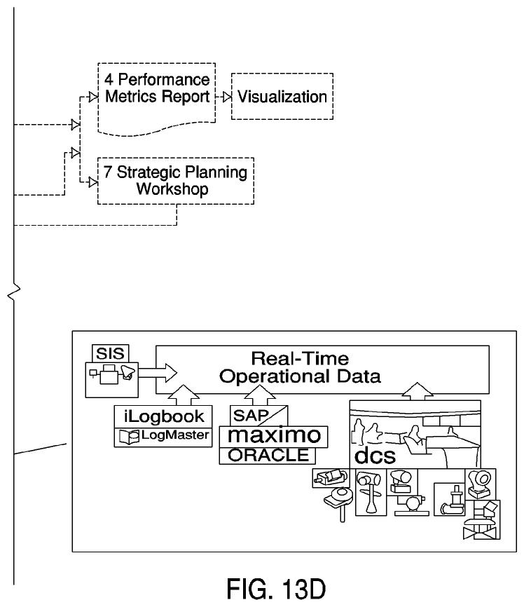

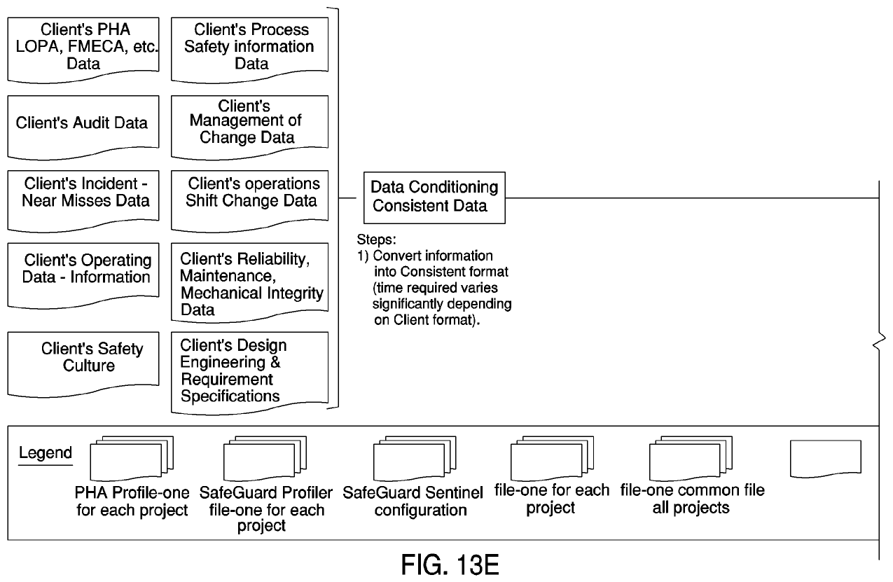

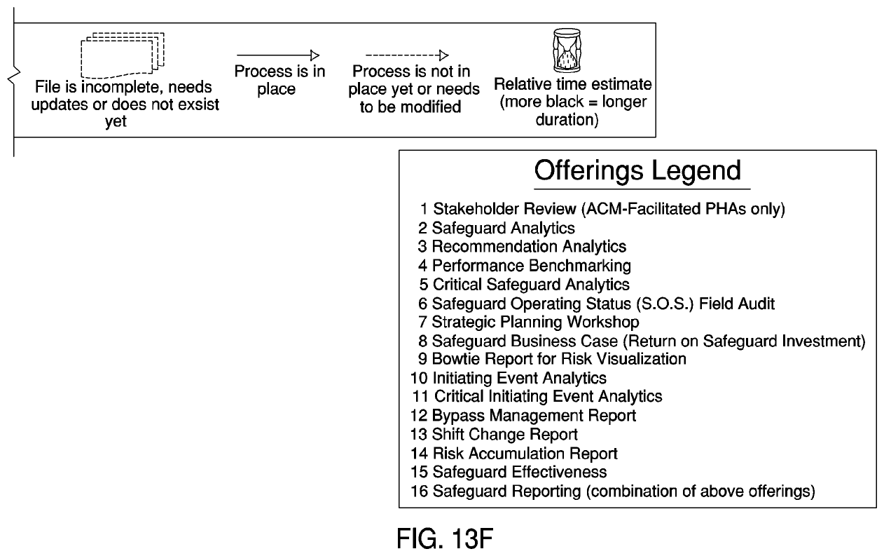

In some aspects of the present disclosure, the various methods disclosed herein may be implemented, in some embodiments, through the use of software or computer code, the software programmed to store the processed data and retrieve the processed data from a relational database. For example, not intended to be limiting, in one embodiment of the present disclosure the relational database may advantageously be located on a cloud-based server, and the software or applications that retrieve the processed data and perform analytics on the processed data may reside on the same cloud-based server or servers. End users of the system may access the software through a general purpose computer loaded with internet browser software, and the internet browser may be utilized to access the software and database through a secured internet portal, whereby access to the portal is granted after authenticating that the user has authority to access the data, for example by use of a username and password, or other authentication means known to a person skilled in the art. In one embodiment, the user may access their processed PHA data through the portal, but may be restricted from accessing PHA data in the relational database provided by other sources. In such embodiments, the user may only gain access to PHA data from sources other than the user in the form of analytic reports produced by a controller of the software, whereby the PHA data from other sources is provided in aggregate form only (for example, not intended to be limiting, the aggregate data presented in an output, the output presented in the form of a benchmark profile line, representing an average analytic calculated from selected benchmark facilities operated by operators other than the user). It will be appreciated by a person skilled in the art that other system designs for implementing the methods described herein are also intended to be included in the scope of the present disclosure. An example of a PHA Analytics system, not intended to be limiting, is illustrated in FIGS. 13A-13F.

1. A method for improving process safety of an unknown facility by performing risk analytics on process hazard analysis (PHA) and layer of protection analysis (LOPA) data sets obtained from a plurality of facilities, the method comprising:
digitizing the PHA and LOPA data sets by categorizing and classifying data elements of the said data sets into categories and classifications, the categories and classifications standardized across the said data sets so as to generate a relational database;
performing full analytics on the data sets of the plurality of facilities in the relational database to generate a profile of each facility,
performing partial analytics on data of the unknown facility to generate an initial profile of the unknown facility,
comparing the initial profile of the unknown facility to the profiles of each facility of the plurality of facilities to identify one or more facilities having a risk profile that is predicted to be similar to the risk profile of the unknown facility,
predicting a percentage of total discovered risks of the unknown facility based on a calculated percentage of total discovered risks of the identified one or more facilities having a similar risk profile,
ranking a selected group of unknown facilities in order of priority by prioritizing the unknown facilities with the lowest predicted percentage of total discovered risks for performing the full analytics so as to validate one or more recommendations associated with the PHA and LOPA data sets of the said prioritized unknown facilities,
implementing the validated recommendations of the said prioritized unknown facilities.

2. (canceled)

3. The method of claim 1, wherein the step of implementing the validated recommendations of the prioritized unknown facilities includes implementing one or more recommended safeguards.

4. The method of claim 1, wherein the step of performing partial analytics on the data of the unknown facility to generate an initial profile of the unknown facility further includes generating groupings of data elements.

5. (canceled)

6. A method for improving process safety of a facility by identifying patterns in process hazard analysis (PHA) data obtained from a plurality of facilities, the method comprising:
conditioning a plurality of PHA data sets obtained from the plurality of facilities so as to generate a relational database wherein at least one of the conditioned PHA data sets relates to the facility, the relational database comprising:
conditioned data elements,
a plurality of hazardous scenarios, each hazardous scenario having assigned data elements selected from the conditioned data elements,
group representations, the group representations generated by grouping together two or more hazardous scenarios wherein the two or more hazardous scenarios share at least one common assigned data element,
performing risk analytics on the plurality of hazardous scenarios in the relational database, outputting a recommendation for reducing a probability of a risk of at least one hazardous scenario of the facility,
implementing the said recommendation at the facility.

7. The method of claim 6, wherein the step of performing risk analytics includes:
performing a risk analysis on the plurality of hazardous scenarios in the relational database to output a recommendation for reducing a risk of at least one hazardous scenario of the facility, the performing of the risk analysis comprising:
identifying at least one cause of the at least one hazardous scenario and a frequency of each identified cause,
identifying at least one safeguard of the at least one hazardous scenario impacting each cause and a probability of failure on demand (PFD) of each identified safeguard,
computing a mitigated frequency of each cause of the at least one hazardous scenario by multiplying the frequency of each cause by the PFD of each safeguard impacting each cause,
computing a total mitigated frequency of the at least one hazardous scenario by summing the mitigated frequency of each cause,
comparing the total mitigated frequency to a tolerable frequency of the at least one hazardous scenario,
outputting the recommendation for reducing the risk of the at least one hazardous scenario of the facility when the total mitigated frequency exceeds the tolerable frequency.

8. The method of claim 6, wherein the recommendation includes adding a new safeguard to the facility.

9. The method of claim 6, wherein the assigned data elements selected from the conditioned data elements include data elements obtained from any of the facilities of the plurality of facilities.

10. The method of claim 9, wherein each facility of the plurality of facilities is operated by a different operator.

11. A system for performing the method of claim 6 for improving process safety of a facility of an operator, the system comprising:
the relational database further comprising a plurality of PHA and layer of protection analysis (LOPA) data sets, each PHA or LOPA data set containing categorized and classified safety data elements wherein the categories and classifications of the safety data elements are consistent between all PHA and LOPA data sets,
a risk analysis module configured to identify and retrieve safety data elements from the relational database in accordance with a risk analysis criteria, perform a risk analysis on the retrieved safety data elements and output the said recommendation for reducing the probability of the risk of at least one hazardous scenario of the facility,
a device for displaying an output of the risk analysis module.

12. The system of claim 11 wherein the plurality of PHA and LOPA data sets includes PHA and LOPA data sets relating to two or more facilities.

13. The system of claim 12 wherein the two or more facilities includes the facility of the operator.

14. The system of claim 12 wherein the two or more facilities are operated by two or more operators, wherein the two or more operators are unrelated to each other.

15. A method for improving process safety of a first facility of an operator, the method comprising:
conditioning a plurality of process hazard analysis (PHA) and layer of protection analysis (LOPA) data sets to generate a relational database, the conditioning steps including:
categorizing and classifying data elements of each PHA or LOPA data set into corresponding categories and classifications which are consistent between all PHA and LOPA data sets,
generating a plurality of hazardous scenarios by identifying a plurality of hazardous events and assigning said data elements to each hazardous event,
grouping together two or more of said hazardous scenarios so as to generate a group representation, wherein the said two or more hazardous scenarios share at least a common hazardous event and a common said data element,
performing a risk analysis procedure on a plurality of identified hazardous events in the relational database, each identified hazardous event belonging to at least one hazardous scenario forming at least one grouped representation in the relational database, the performing steps including:
identifying one or more causes of each identified hazardous event and a frequency of each identified one or more causes,
identifying one or more safeguards of the identified hazardous event impacting each cause and a probability of failure on demand (PFD) of each identified safeguard,
performing calculations to obtain a total mitigated frequency and a tolerable frequency of the identified hazardous event,
outputting a plurality of recommendations for reducing the risk of each hazardous event of the plurality of identified hazardous events when the total mitigated frequency of an identified hazardous event exceeds the tolerable frequency of the identified hazardous event,
implementing at least one recommendation of the plurality of recommendations at the first facility.

16. The method of claim 15, wherein the categories are selected from the group comprising: a cause, a safeguard, a recommendation, a consequence.

17. The method of claim 16, wherein the step of conditioning a plurality of PHA and LOPA data sets further includes classifying a severity of the consequence of each hazardous scenario of the plurality of hazardous scenarios, and
wherein the step of grouping together two or more hazardous scenarios includes grouping together two or more hazardous scenarios which share equally classified severity of consequences.

18. The method of claim 15, wherein the plurality of PHA and LOPA data sets include PHA or LOPA data sets of the first facility.

19. The method of claim 16, wherein the common data element is a safeguard, and wherein the step of grouping together two or more hazardous scenarios includes grouping together at least a hazardous scenario of the first facility and a hazardous scenario of at least a second facility.

20. The method of claim 19, wherein the second facility is operated by a second operator unrelated to the first operator.

21. The method of claim 17, wherein the step of performing a risk analysis on the relational database includes performing a criticality analysis on a selected category of data elements of the facility, and
wherein the output of the risk analysis includes identifying a critical data element of the selected category of data elements of the facility, and
wherein the at least one recommendation includes a plurality of recommended actions, the plurality of recommended actions prioritized on the basis of which recommended actions will impact the identified critical data element.

22. The method of claim 15, wherein the at least one recommendation comprises implementing a new safeguard.

23. The method of claim 15 wherein the step of implementing at least one recommendation of the plurality of recommendations includes the steps of:
calculating the risk reduction effectiveness (RRE) of each recommendation of the plurality of recommendations,
comparing the RRE of each recommendation of the plurality of recommendations to rank the plurality of recommendations in order of criticality,
prioritizing implementing a critical subset of recommendations selected from the ranked plurality of recommendations.
